(19) United States
(12) Patent Application Publication
(10) Pub. No.: US 2026/0239128 A1
(43) Pub. Date: Aug. 13, 2026

(54) SENSING INFORMATION FOR SENSING AND HANDOVER OPERATIONS

(71) Applicant: QUALCOMM Incorporated, San Diego, CA (US)

(72) Inventors: Shijun WU, San Diego, CA (US); Kapil GULATI, Belle Mead, NJ (US); Preeti KUMARI, San Diego, CA (US); Stelios STEFANATOS, San Diego, CA (US)

(21) Appl. No.: 19/474,984

(22) PCT Filed: May 10, 2024
(86) PCT No.: PCT/US2024/028815

§ 371 Date: Oct. 13, 2025

(30) Foreign Application Priority Data
Jun. 9, 2023 (GR) 20230100459

(51) Int. Cl. H04W 36/00; H04W 36/08

(52) U.S. Cl. CPC H04W 36/0072; H04W 36/08

(57) ABSTRACT

Methods, systems, and devices for wireless communications are described. A source network entity may transmit a handover request to a target network entity indicating that a user equipment (UE) is to handover from the source network entity to the target network entity and indicating sensing information identifying that the UE is performing a sensing operation. The target network entity may transmit a response message to the source network entity indicating a sensing scheme enabling the UE to perform sensing during the handover and in some cases, authorizing the handover. Based on receiving the response message, the source network entity may transmit a handover message to the UE triggering the UE to perform handover and to perform the sensing RSs during the handover. The UE may perform the handover and the sensing based on the handover message.

### CROSS REFERENCE

The present Application for Patent is a 371 national phase filing of International Patent Application No. PCT/US2024/028815 by WU et al., entitled “SENSING INFORMATION FOR SENSING AND HANDOVER OPERATIONS,” filed May 10, 2024, which claims priority to Greek Patent Application No. 20230100459 by WU et al., entitled “SENSING INFORMATION FOR SENSING AND HANDOVER OPERATIONS,” filed Jun. 9, 2023, each of which is assigned to the assignee hereof, and each of which is expressly incorporated by reference herein.

### FIELD OF TECHNOLOGY

The present disclosure relates to wireless communications, including indicating sensing information for sensing and handover operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sensing information for sensing and handover operations. For example, the described techniques provide for a user equipment (UE) performing a sensing operation and a handover from a source network entity to a target network entity based on some indicated sensing information. A source network entity may transmit a handover request to a target network entity requesting that a sensing UE be handed over from the source network entity to the target network entity. The handover request may indicate sensing information associated with a sensing operation of the UE for object detection. The target network entity may transmit a response message to the source network entity indicating whether the handover is admitted and indicating whether the UE may perform the sensing operation according to a sensing scheme that is based on the sensing information. Based on receiving the response message, the source network entity may transmit a handover message to the UE triggering the UE to perform handover. In some cases, the handover message may indicate resources for transmitting sensing reference signals (RSs) during the handover.

A method for wireless communications at a source network entity is described. The method may include transmitting, to a target network entity, a handover request for handover of a UE from the source network entity to the target network entity, the handover request indicating sensing information identifying that the UE is performing a sensing operation for object detection, receiving, from the target network entity, a response message indicating a sensing scheme to enable the UE to perform sensing during the handover from the source network entity to the target network entity, the sensing scheme based on the sensing information, and transmitting, to the UE, a handover message triggering the UE to perform the handover from the source network entity to the target network entity and to perform the sensing operation in accordance with the sensing scheme during the handover.

An apparatus for wireless communications at a source network entity is described. The apparatus may include at least one memory, and at least one processor coupled with the at least one memory, the at least one processor configured to: transmit, to a target network entity, a handover request for handover of a UE from the source network entity to the target network entity, the handover request indicating sensing information identifying that the UE is performing a sensing operation for object detection, receive, from the target network entity, a response message indicating a sensing scheme to enable the UE to perform sensing during the handover from the source network entity to the target network entity, the sensing scheme based on the sensing information, and transmit, to the UE, a handover message triggering the UE to perform the handover from the source network entity to the target network entity and to perform the sensing operation in accordance with the sensing scheme during the handover.

Another apparatus for wireless communications at a source network entity is described. The apparatus may include means for transmitting, to a target network entity, a handover request for handover of a UE from the source network entity to the target network entity, the handover request indicating sensing information identifying that the UE is performing a sensing operation for object detection, means for receiving, from the target network entity, a response message indicating a sensing scheme to enable the UE to perform sensing during the handover from the source network entity to the target network entity, the sensing scheme based on the sensing information, and means for transmitting, to the UE, a handover message triggering the UE to perform the handover from the source network entity to the target network entity and to perform the sensing operation in accordance with the sensing scheme during the handover.

A non-transitory computer-readable medium storing code for wireless communications at a source network entity is described. The code may include instructions executable by a processor to transmit, to a target network entity, a handover request for handover of a UE from the source network entity to the target network entity, the handover request indicating sensing information identifying that the UE is performing a sensing operation for object detection, receive, from the target network entity, a response message indicating a sensing scheme to enable the UE to perform sensing during the handover from the source network entity to the target network entity, the sensing scheme based on the sensing information, and transmit, to the UE, a handover message triggering the UE to perform the handover from the source network entity to the target network entity and to perform the sensing operation in accordance with the sensing scheme during the handover.

In some examples of the method, apparatuses, and non-transitory computer-readable medium described herein, transmitting the handover request may include operations, features, means, or instructions for transmitting, to an access and mobility management function (AMF) for relay to the target network entity as the handover request, a handover instruction message that instructs the target network entity to coordinate with the source network entity for the handover of the UE to the target network entity.

In some examples of the method, apparatuses, and non-transitory computer-readable medium described herein, receiving the response message may include operations, features, means, or instructions for receiving the response message indicating that the target network entity authorizes the UE to perform the sensing operation during the handover based on the handover request indicating the sensing information.

In some examples of the method, apparatuses, and non-transitory computer-readable medium described herein, transmitting the handover request may include operations, features, means, or instructions for transmitting, via the handover request, the sensing information that indicates a requested resource allocation for performing the sensing operation during the handover, where the sensing scheme may be based on the requested resource allocation.

In some examples of the method, apparatuses, and non-transitory computer-readable medium described herein, the sensing scheme indicated by the response message identifies a resource allocation for performing the sensing operation during the handover that may be the same as or may be different from the requested resource allocation.

In some examples of the method, apparatuses, and non-transitory computer-readable medium described herein, the response message indicates a time duration during which the resource allocation may be available for performing the sensing operation.

In some examples of the method, apparatuses, and non-transitory computer-readable medium described herein, the sensing scheme enables the UE to initiate a random access procedure with the target network entity, where the random access procedure includes transmission of one or more sensing RSs via a requested resource allocation during the handover.

In some examples of the method, apparatuses, and non-transitory computer-readable medium described herein, the sensing information indicates one or more sensing service parameters associated with performing the sensing operation, where the one or more sensing service parameters include at least a sensing distance parameter, or a sensing velocity parameter, or a sensing angular parameter, or a sensing signal configuration, or a combination thereof, and where the sensing scheme indicates to use or a modification to at least one of the one or more sensing service parameters.

In some examples of the method, apparatuses, and non-transitory computer-readable medium described herein, receiving the response message may include operations, features, means, or instructions for receiving, from the target network entity, the response message including a handover request acknowledgement message indicating the sensing scheme.

In some examples of the method, apparatuses, and non-transitory computer-readable medium described herein, receiving the response message may include operations, features, means, or instructions for receiving, from an AMF, a handover command indicating the sensing scheme.

In some examples of the method, apparatuses, and non-transitory computer-readable medium described herein, the handover message may be a radio resource control message, a handover command, or both.

A method for wireless communications at a target network entity is described. The method may include receiving, from a source network entity, a handover request for handover of a UE from the source network entity to the target network entity, the handover request indicating sensing information identifying that the UE is performing a sensing operation for object detection and transmitting, to the source network entity, a response message indicating a sensing scheme to enable the UE to perform the sensing operation during the handover from the source network entity to the target network entity, the sensing scheme based on the sensing information.

An apparatus for wireless communications at a target network entity is described. The apparatus may include at least one memory, and at least one processor coupled to the at least one memory, the at least one processor configured to: receive, from a source network entity, a handover request for handover of a UE from the source network entity to the target network entity, the handover request indicating sensing information identifying that the UE is performing a sensing operation for object detection and transmit, to the source network entity, a response message indicating a sensing scheme to enable the UE to perform the sensing operation during the handover from the source network entity to the target network entity, the sensing scheme based on the sensing information.

Another apparatus for wireless communications at a target network entity is described. The apparatus may include means for receiving, from a source network entity, a handover request for handover of a UE from the source network entity to the target network entity, the handover request indicating sensing information identifying that the UE is performing a sensing operation for object detection and means for transmitting, to the source network entity, a response message indicating a sensing scheme to enable the UE to perform the sensing operation during the handover from the source network entity to the target network entity, the sensing scheme based on the sensing information.

A non-transitory computer-readable medium storing code for wireless communications at a target network entity is described. The code may include instructions executable by a processor to receive, from a source network entity, a handover request for handover of a UE from the source network entity to the target network entity, the handover request indicating sensing information identifying that the UE is performing a sensing operation for object detection and transmit, to the source network entity, a response message indicating a sensing scheme to enable the UE to perform the sensing operation during the handover from the source network entity to the target network entity, the sensing scheme based on the sensing information.

In some examples of the method, apparatuses, and non-transitory computer-readable medium described herein, receiving the handover request may include operations, features, means, or instructions for receiving, from an AMF, the handover request that instructs the target network entity to coordinate with the source network entity for the handover of the UE to the target network entity.

In some examples of the method, apparatuses, and non-transitory computer-readable medium described herein, transmitting the response message may include operations, features, means, or instructions for transmitting the response message indicating that the target network entity authorizes the UE to perform the sensing operation during the handover based on the handover request indicating the sensing information.

In some examples of the method, apparatuses, and non-transitory computer-readable medium described herein, receiving the handover request may include operations, features, means, or instructions for receiving, via the handover request, the sensing information that indicates a requested resource allocation for performing the sensing operation during the handover, where the sensing scheme may be based on the requested resource allocation.

In some examples of the method, apparatuses, and non-transitory computer-readable medium described herein, the sensing scheme indicated by the response message identifies a resource allocation for performing the sensing operation during the handover that may be the same as or may be different from the requested resource allocation.

In some examples of the method, apparatuses, and non-transitory computer-readable medium described herein, the requested resource allocation may be based on a resource allocation associated with the target network entity, an interference measurement, or both.

In some examples of the method, apparatuses, and non-transitory computer-readable medium described herein, the response message indicates a time duration during which the requested resource allocation may be available for performing the sensing operation.

In some examples of the method, apparatuses, and non-transitory computer-readable medium described herein, the sensing scheme includes an instruction that instructs the UE to initiate a random access procedure with the target network entity.

In some examples of the method, apparatuses, and non-transitory computer-readable medium described herein, receiving the handover request may include operations, features, means, or instructions for receiving, from an AMF, a status transfer message indicating the sensing information.

In some examples of the method, apparatuses, and non-transitory computer-readable medium described herein, the sensing information indicates one or more sensing service parameters associated with performing the sensing operation, where the one or more sensing service parameters include at least a sensing distance parameter, or a sensing velocity parameter, or a sensing angular parameter, or a sensing signal configuration, or a combination thereof, and where the sensing scheme indicates to use or a modification to at least one of the one or more sensing service parameters.

In some examples of the method, apparatuses, and non-transitory computer-readable medium described herein, transmitting the response message may include operations, features, means, or instructions for transmitting, to the source network entity, the response message including a handover request acknowledgement message indicating the sensing scheme.

In some examples of the method, apparatuses, and non-transitory computer-readable medium described herein, transmitting the response message may include operations, features, means, or instructions for transmitting, to an AMF, a handover request acknowledgement message indicating the sensing scheme.

A method for wireless communications at a UE is described. The method may include receiving, from a source network entity, a handover message triggering the UE to perform a handover from the source network entity to a target network entity and indicating to perform a sensing operation in accordance with a sensing scheme during the handover, performing the handover from the source network entity to the target network entity based on receiving the handover message, and performing the sensing operation during the handover in accordance with the sensing scheme based on receiving the handover message.

An apparatus for wireless communications at a UE is described. The apparatus may include at least one memory, and at least one processor coupled to the at least one memory, the at least one processor configured to: receive, from a source network entity, a handover message triggering the UE to perform a handover from the source network entity to a target network entity and indicating to perform a sensing operation in accordance with a sensing scheme during the handover, perform the handover from the source network entity to the target network entity based on receiving the handover message, and perform the sensing operation during the handover in accordance with the sensing scheme based on receiving the handover message.

Another apparatus for wireless communications at a UE is described. The apparatus may include means for receiving, from a source network entity, a handover message triggering the UE to perform a handover from the source network entity to a target network entity and indicating to perform a sensing operation in accordance with a sensing scheme during the handover, means for performing the handover from the source network entity to the target network entity based on receiving the handover message, and means for performing the sensing operation during the handover in accordance with the sensing scheme based on receiving the handover message.

A non-transitory computer-readable medium storing code for wireless communications at a UE is described. The code may include instructions executable by a processor to receive, from a source network entity, a handover message triggering the UE to perform a handover from the source network entity to a target network entity and indicating to perform a sensing operation in accordance with a sensing scheme during the handover, perform the handover from the source network entity to the target network entity based on receiving the handover message, and perform the sensing operation during the handover in accordance with the sensing scheme based on receiving the handover message.

In some examples of the method, apparatuses, and non-transitory computer-readable medium described herein, receiving the handover message may include operations, features, means, or instructions for receiving the handover message indicating that the target network entity authorizes the UE to perform the sensing operation during the handover.

In some examples of the method, apparatuses, and non-transitory computer-readable medium described herein, the sensing scheme indicates a resource allocation for performing the sensing operation.

In some examples of the method, apparatuses, and non-transitory computer-readable medium described herein, the handover message indicates a time duration during which a resource allocation may be available for performing the sensing operation.

In some examples of the method, apparatuses, and non-transitory computer-readable medium described herein, the sensing scheme indicates a first resource allocation for performing the sensing operation during the handover that may be the same as or may be different from a second resource allocation used by the UE for performing the sensing operation prior to the handover.

In some examples of the method, apparatuses, and non-transitory computer-readable medium described herein, one or more sensing service parameters may be associated with performing the sensing operation, where the one or more sensing service parameters include at least a sensing distance parameter, or a sensing velocity parameter, or a sensing angular parameter, or a sensing signal configuration, or a combination thereof, and where the sensing scheme indicates to use or a modification to at least one of the one or more sensing service parameters.

In some examples of the method, apparatuses, and non-transitory computer-readable medium described herein, the sensing scheme includes an instruction that instructs the UE to initiate a random access procedure with the target network entity.

In some examples of the method, apparatuses, and non-transitory computer-readable medium described herein, performing the sensing operation may include operations, features, means, or instructions for transmitting one or more sensing RSs during the handover via a first resource allocation that may be the same as a second resource allocation used by the UE for performing the sensing operation prior to the handover.

In some examples of the method, apparatuses, and non-transitory computer-readable medium described herein, performing the sensing operation may include operations, features, means, or instructions for transmitting one or more sensing RSs during the handover via a first resource allocation that may be different from a second resource allocation used by the UE for performing the sensing operation prior to the handover.

In some examples of the method, apparatuses, and non-transitory computer-readable medium described herein, performing the handover may include operations, features, means, or instructions for initiating a random access procedure with the target network entity based on receiving the handover message.

In some examples of the method, apparatuses, and non-transitory computer-readable medium described herein, the handover message may be a radio resource control message, a handover command, or both.

### BRIEF DESCRIPTION OF THE DRAWINGS

FIG. 1 shows an example of a wireless communications system that supports indicating sensing information for sensing and handover operations in accordance with one or more aspects of the present disclosure.

FIG. 2 shows an example of a wireless communications system that supports indicating sensing information for sensing and handover operations in accordance with one or more aspects of the present disclosure.

FIG. 3 shows an example of a sensing scheme diagram that supports indicating sensing information for sensing and handover operations in accordance with one or more aspects of the present disclosure.

FIG. 4 shows an example of a process flow that supports indicating sensing information for sensing and handover operations in accordance with one or more aspects of the present disclosure.

FIGS. 5 and 6 show block diagrams of devices that support indicating sensing information for sensing and handover operations in accordance with one or more aspects of the present disclosure.

FIG. 7 shows a block diagram of a communications manager that supports indicating sensing information for sensing and handover operations in accordance with one or more aspects of the present disclosure.

FIG. 8 shows a diagram of a system including a device that supports indicating sensing information for sensing and handover operations in accordance with one or more aspects of the present disclosure.

FIGS. 9 and 10 show block diagrams of devices that support indicating sensing information for sensing and handover operations in accordance with one or more aspects of the present disclosure.

FIG. 11 shows a block diagram of a communications manager that supports indicating sensing information for sensing and handover operations in accordance with one or more aspects of the present disclosure.

FIG. 12 shows a diagram of a system including a device that supports indicating sensing information for sensing and handover operations in accordance with one or more aspects of the present disclosure.

FIGS. 13 through 18 show flowcharts illustrating methods that support indicating sensing information for sensing and handover operations in accordance with one or more aspects of the present disclosure.

### DETAILED DESCRIPTION

A wireless communications system may include user equipments (UEs) and network entities, and each network entity may be associated with a coverage area (e.g., a cell). A UE may perform a sensing operation by transmitting one or more sensing signals (e.g., sensing reference signals (RSs)) via one or more resources configured by a network entity, and receiving one or more reflections of the RSs off of an object to determine or estimate the object's location, velocity, or both. In some cases, the UE (e.g., a vehicle UE or other mobile wireless device) may have high mobility and may move between cells, which may include performing frequent handover procedures. For example, the UE may handover from a first network entity and a first cell to a second network entity and a second cell. However, the handover may interrupt the sensing operation being performed at the UE, which may introduce safety risks (e.g., delayed or missed object identification, ghost objects, etc.), which may by unacceptable in safety-related automotive use cases.

Various aspects of the present disclosure are related to indicating sensing information for sensing and handover operations. A source network entity (also referred to herein as a source network node) may transmit a handover request to a target network entity (also referred to herein as a target network node) requesting a handover of a UE from the source network entity to the target network entity. In addition, the handover request may indicate sensing information identifying that the UE is currently performing a sensing operation for object detection.

Responsive to receiving the handover request from the source network entity, the target network entity may send a response message to the source network entity indicating whether handover of the UE is admitted and indicating a sensing scheme that enables the UE to perform sensing during the handover. In some cases, the response message may configure a second set of resources to be used for performing the sensing operation during the handover. Based on receiving the response message from the target network entity, the source network entity may transmit a handover message to the UE. The handover message may trigger the UE to perform handover and to perform the sensing operation in accordance with the sensing scheme and during the handover. Additionally, or alternatively, the handover message may indicate one or more resources to be used for transmitting sensing RSs during the handover. The UE may perform the handover based on receiving the handover message, and the UE may perform the sensing in accordance with the sensing scheme during the handover.

Aspects of the disclosure are initially described in the context of wireless communications systems. Aspects of the disclosure are additionally illustrated with reference to sensing scheme diagrams and process flows. Aspects of the disclosure are further illustrated by and described with reference to apparatus diagrams, system diagrams, and flowcharts that relate to indicating sensing information for sensing and handover operations.

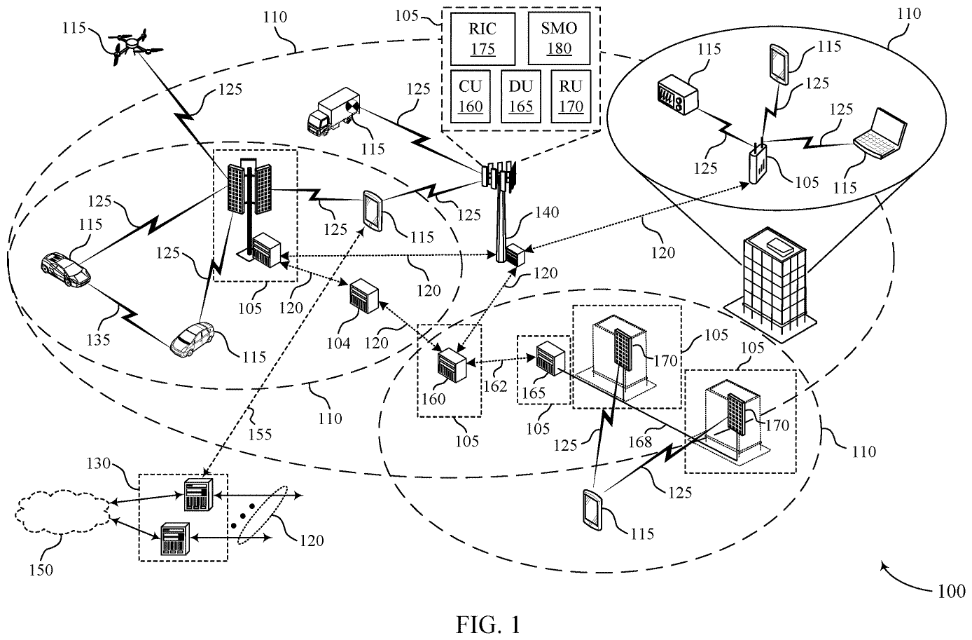

FIG. 1 shows an example of a wireless communications system 100 that supports indicating sensing information for sensing and handover operations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or a combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or a combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and a combination thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support indicating sensing information for sensing and handover operations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or a combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, RSs, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit an RS (e.g., a cell-specific RS (CRS), a channel state information RS (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook).

Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, RSs, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support the indication of sensing information for sensing and handover operations. A source network entity 105 may transmit a handover request to a target network entity 105 requesting a handover of a sensing UE 115 from the source network entity 105 to the target network entity 105. The handover request may indicate sensing information associated with a sensing operation currently being performed by the UE 115 for object detection. The target network entity 105 may transmit a response message to the source network entity 105 indicating whether the handover is admitted and indicating whether the UE 115 may perform the sensing operation during the handover according to a sensing scheme that is based on the sensing information. Based on receiving the response message, the source network entity 105 may transmit a handover message to the UE 115 triggering the UE 115 to perform handover. In some cases, the handover message may indicate resources for transmitting sensing RSs during the handover.

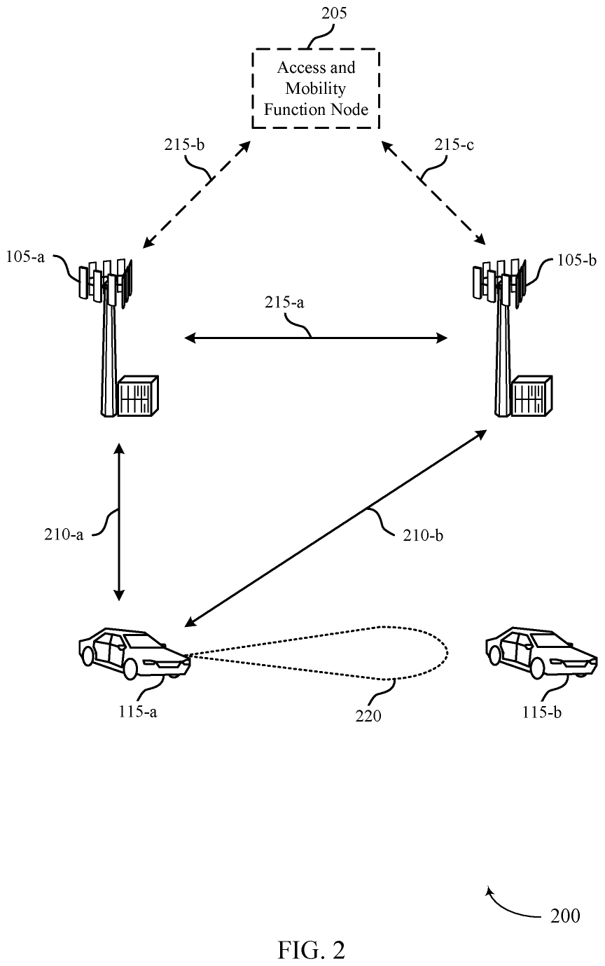

FIG. 2 shows an example of a wireless communications system 200 that supports indicating sensing information for sensing and handover operations in accordance with one or more aspects of the present disclosure. The wireless communications system 200 may include a source network entity 105-a, a target network entity 105-b, a first UE 115-a, a second UE 115-b, and an AMF 205, which may be examples of corresponding devices described herein, including with respect to FIG. 1. The network entities 105 may also be referred to herein as network nodes. In some examples, the first UE 115-a and the second UE 115-b may be located in or otherwise associated with vehicles. The first UE 115-a may communicate with the source network entity 105-a via cellular communication link 210-a (e.g., a Uu link) and the target network entity 105-b via cellular communications link 210-b. The source network entity 105-a may communicate with the target network entity 105-b via network link 215-a (e.g., Xn link). The AMF 205 may communicate with the source network entity 105-a via network link 215-b (e.g., N2 link) and the target network entity 105-b via network link 215-c (e.g., N2 link).

The first UE 115-a may support a joint sensing and communication system (for example, to reduce hardware costs). For example, in a V2V communications system, the first UE 115-a may transmit a sensing RS 220 and detect an echo of the sensing RS 220 (e.g., a reflected sensing RS) in a monostatic operation. The first UE 115-a may use this signaling to detect objects (e.g., the second UE 115-b) around the first UE 115-a and estimate a velocity of the first UE 115-a. In such examples, the first UE 115-a may be full-duplex capable in order to detect the reflected sensing RS. In some cases, the first UE 115-a may transmit multiple sensing RSs 220 via underutilized cellular communication frequency bands (e.g., mmW bands) of the wireless communications system 200. In such cases, the first UE 115-a may transmit the sensing RS 220 using uplink resources of the cellular communication frequency bands, which may be configured or allocated by the source network entity 105-a, the target network entity 105-b, or both. For example, the uplink resource may be semi-statically configured via RRC signaling, a configured grant, or a combination thereof. Additionally, or alternatively, the sensing RS 220 may reuse the same waveform as used in the wireless communications system 200 (e.g., cyclic-prefix OFDM (CP-OFDM)). The first UE 115-a may transmit the multiple sensing RSs 220 to establish continuous detection and tracking of objects within a sensing field of view (FoV).

In some examples, the first UE 115-a may have high mobility and may move between coverage areas associated with network entities 105. For example, the first UE 115-a may communicate with the source network entity 105-a. The first UE 115-a may exit a first coverage area associated with the source network entity 105-a and may enter a second coverage area associated with the target network entity 105-b. Accordingly, the first UE 115-a may perform handover (e.g., a handover operation) to release resources associated with the source network entity 105-a and begin communicating with the target network entity 105-b.

To facilitate handover of the first UE 115-a, the source network entity 105-a may transmit an indication of sensing information to the target network entity 105-b. The sensing information may indicate that the first UE 115-a is performing sensing (e.g., is transmitting the sensing RS 220). Additionally, or alternatively, the sensing information may indicate that the first UE 115-a is to handover from the source network entity 105-a to the target network entity 105-b. In some cases, the first UE 115-a may not have user plane data associated with the target network entity 105-b, the target network entity 105-b may not have user plane data associated with the first UE 115-a, or both. In such cases, the target network entity 105-b may allocate resources to the first UE 115-a for transmitting the sensing RS 220 (e.g., monostatic sensing) based on receiving the indication of the sensing information.

In some examples, the sensing information may include sensing service requirements of the first UE 115-a. For example, the sensing service requirements may include one or more sensing key performance indicators (KPIs), including a sensing distance requirement (e.g., a maximum distance, a distance resolution), a sensing velocity requirement (e.g., a maximum velocity, a velocity resolution), a sensing angular requirement (e.g., a FoV, a quantity of beams, an angular resolution), or any combination thereof. Additionally, or alternatively, the sensing service requirements may include a desired sensing signal configuration, including a bandwidth, a time duration, a quantity of beams, a periodicity, a time-comb, a frequency-comb, or a combination thereof.

In some other examples, the source network entity 105-a may configure resources for sensing signal transmission by the first UE 115-a and may indicate the resource configuration to the target network entity 105-b. In some cases, based on receiving the indication of the resource configuration, the target network entity 105-b may determine whether the first UE 115-a is to transmit the sensing RS 220 during the handover via the resources configured by the source network entity 105-a. In some other cases, based on receiving the indication of the resource configuration, the target network entity 105-b may configure resources for the first UE 115-a transmitting the sensing RS 220 during the handover using the indication as a reference.

In some cases, the flow of sensing information transmission may be dependent on handover type. In some examples (e.g., Xn handover), the source network entity 105-a may indicate the sensing information directly to the target network entity 105-b via a handover request message. In some other cases (e.g., N2 handover), the source network entity 105-a may indicate the sensing information to the AMF 205 via a handover required message. In yet some other cases, the source network entity 105-a may transmit an indication that the first UE 115-a is performing sensing via a handover request message or a handover required message to the AMF 205, and the AMF 205 may indicate additional sensing information (e.g., sensing service requirements, resource configuration) to the target network entity 105-b via a status transfer message.

Based on receiving the sensing information, the target network entity 105-b may determine whether handover of the first UE 115-a is admitted (e.g., for a sensing operation). Accordingly, the target network entity 105-b may transmit a response message that authorizes (e.g., admits) the first UE 115-a to perform the sensing operation during the handover based on the sensing information. In some cases (e.g., Xn handover), the target network entity 105-b may transmit the response message to the source network entity 105-a via a handover request acknowledge message. In some other cases (e.g., N2 handover), the target network entity 105-b may transmit the response message to the AMF 205 via a handover request acknowledge message, and the AMF 205 may transmit the response message to the source network entity 105-a via a handover command message.

In some examples, the response message may indicate a sensing scheme (e.g., a resource allocation) for transmitting the sensing RS 220 during handover. The first UE 115-a may transmit the sensing RS 220 via the resources configured by the target network entity 105-b during handover and prior to receiving a direct sensing signal resource configuration from the target network entity 105-b. For example, during the handover, the first UE 115-a may release resources configured by the source network entity 105-a and may transmit the sensing RS 220 using resources indicated in the response message. In some cases, the first UE 115-a may transmit the sensing RS 220 after receiving timing advance or timing alignment information from the target network entity 105-b. After the handover, the target network entity 105-b may configure the first UE 115-a with one or more sensing signal resources (e.g., via RRC reconfiguration), and the first UE 115-a may transmit the sensing RS 220 via the one or more sensing signal resources.

In some other examples, based on receiving the indication of the resource configuration from the source network entity 105-a, the target network entity 105-b may determine that the first UE 115-a is to transmit the sensing RSs 220 via resources configured by the source network entity 105-a during handover and prior to receiving the sensing signal resource configuration from the target network entity 105-b after the handover. For example, the target network entity 105-b may transmit a response message indicating that the first UE 115-a is to transmit the sensing RSs 220 via resources configured by the source network entity 105-a during the handover based on a resource allocation associated with the target network entity 105-b, an interference measurement, or a combination thereof. Additionally, or alternatively, the response message may indicate a time duration (e.g., a timer) during which the first UE 115-a may use the resources configured by the source network entity 105-a. After expiration of the timer, the first UE 115-a may transmit a request to the target network entity 105-b, the request for resources for transmitting the sensing RS 220.

Based on receiving the response message, the source network entity 105-a may transmit a handover message to the first UE 115-a. The handover message may be included in an RRC reconfiguration message, a handover command message, or a combination thereof. In some examples, the handover message may indicate that the first UE 115-a is authorized (e.g., admitted) to perform a sensing operation during the handover, and the handover message may trigger the first UE 115-a to perform the handover. For example, the first UE 115-a may initiate a random access procedure with the target network entity 105-b based on receiving the handover command message from the source network entity 105-a.

In some examples, the handover message may indicate that the first UE 115-a may transmit the sensing RS 220 using resources configured by the source network entity 105-a during the handover. Additionally, or alternatively, the handover message may indicate a timer, a duration, or a combination thereof associated with the resources configured by the source network entity 105-a. In some other examples, the handover message may configure new resources for the first UE 115-a to transmit the sensing RS 220 prior to receiving a resource configuration from the target network entity 105-b after the handover. For example, the source network entity 105-a may transmit the handover message configuring the first UE 115-a with resources associated with the target network entity 105-b based on receiving the response message from the target network entity 105-b. The first UE 115-a may transmit one or more sensing RSs 220 during handover based on receiving the handover message from the source network entity 105-a.

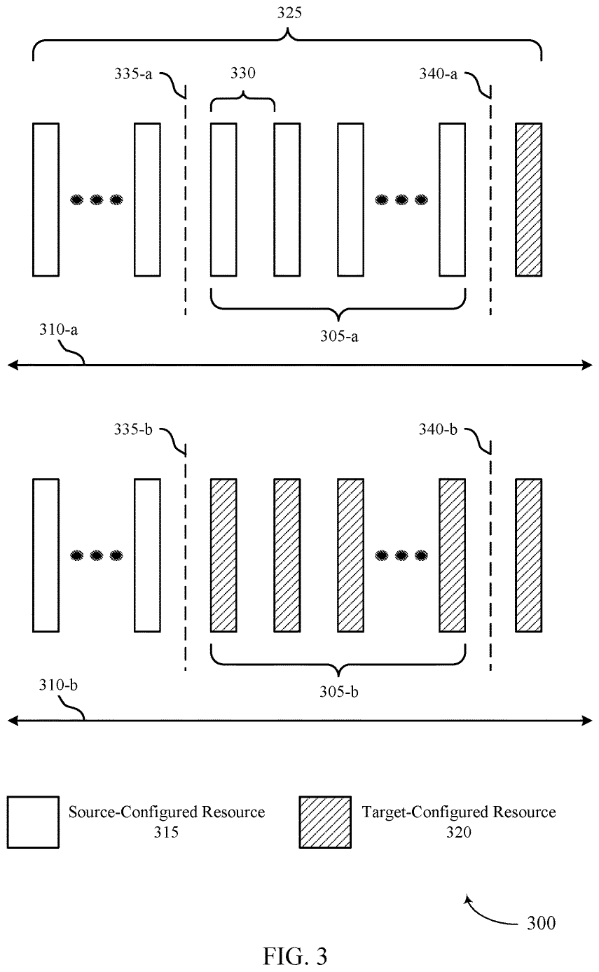

FIG. 3 shows an example of a sensing scheme diagram 300 that supports indicating sensing information for sensing and handover operations in accordance with one or more aspects of the present disclosure. The sensing scheme diagram 300 may be implemented by aspects of the wireless communications system 200 as described with reference to FIGS. 1 and 2. For instance, in the example of FIG. 3, a UE may handover from a source network entity to a target network entity, and may transmit one or more sensing RSs during the handover in accordance with a sensing scheme 305, which may be a first sensing scheme 305-a or a second sensing scheme 305-b. The UE may receive an indication of the first sensing scheme 305-a or the second sensing scheme 305-b in a handover message transmitted from the source network entity. Each sensing scheme 305 may be associated with a time duration 310, such as a time duration 310-a or a time duration 310-b, respectively.

A UE may transmit sensing RSs via one or more resource blocks, which may include source-configured resources 315 (e.g., resources configured by the source network entity) or target-configured resources 320 (e.g., resources configured by the target network entity). The resource blocks may include one or more consecutive OFDM symbols carrying sensing RSs. The UE may transmit the sensing RSs periodically during a cyclic prefix interval (CPI) 325. For example, the sensing RSs may be separated by an interval 330, which may be uniform or non-uniform across the CPI 325.

In some examples, the UE may transmit sensing RSs according to the first sensing scheme 305-a. In such examples, before handing over from the source network entity to the target network entity (e.g., before a time 335-a), the UE may transmit one or more sensing RSs via source-configured resources 315. During the handover (e.g., after the time 335-a and before a time 340-a), the UE may continue to transmit the sensing RSs via the source-configured resources 315. In some cases, the UE may determine a time 340-a based on a timer or a duration indicated in signaling to the UE as described with reference to FIG. 2. After the handover (e.g., after the time 340-a), the UE may transmit the sensing RSs via the target-configured resources 320.

In some other examples, the UE may transmit the sensing RSs according to the second sensing scheme 305-b. The second sensing scheme 305-b may be based on an indication of a resource configuration associated with the target network entity. In such examples, before handing over from the source network entity to the target network entity (e.g., before a time 335-b), the UE may transmit one or more sensing RSs via the source-configured resources 315. During the handover (e.g., after the time 335-b and before a time 340-b), the UE may transmit the sensing RSs via the target-configured resources 320. In some cases, the source network entity and the target network entity may negotiate the target-configured resources 320. After the handover (e.g., after the time 340-b), the UE may transmit the sensing RSs via the target-configured resources 320.

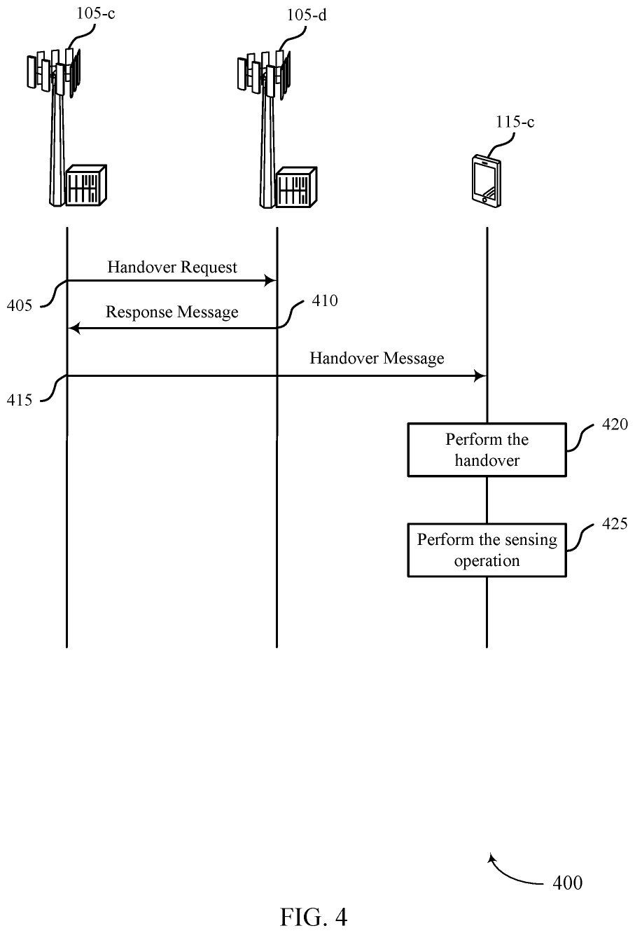

FIG. 4 shows an example of a process flow 400 that supports indicating sensing information for sensing and handover operations in accordance with one or more aspects of the present disclosure. The process flow 400 may implement or be implemented by aspects of the wireless communications system 100 and the wireless communications system 200 as described with reference to FIGS. 1 and 2. For instance, in the example of FIG. 4, a source network entity 105-c may be in communication with a target network entity 105-d and a UE 115-c. The source network entity 105-c and the target network entity 105-d may be examples of network entities 105 or network nodes 105, and the UE 115-c may be an example of a UE 115 as described with reference to FIG. 1. In the following description of the process flow 400, the operations between the source network entity 105-c, the target network entity 105-d, and the UE 115-c may be transmitted in a different order than the example order shown, or the operations between the source network entity 105-c, the target network entity 105-d, and the UE 115-c may be performed in different orders at different times. Some operations may also be omitted from the process flow 400, and other operations may be added to the process flow 400.

At 405, the source network entity 105-c may transmit, to the target network entity 105-d, a handover request for handover of the UE 115-c from the source network entity 105-c to the target network entity 105-d, the handover request indicating sensing information identifying that the UE 115-c is performing a sensing operation for object detection. Additionally, or alternatively, the source network entity 105-c may transmit, to an AMF for relay to the target network entity 105-d as the handover request, a handover instruction message that instructs the target network entity 105-d to coordinate with the source network entity 105-c for the handover of the UE to the target network entity 105-d.

Additionally, the handover request may include sensing information that indicates a requested resource allocation for performing the sensing operation during the handover. In some cases, the requested resource allocation may be based on a resource allocation associated with the target network entity 105-d, an interference measurement, or both. The sensing information transmitted by the source network entity 105-c may indicate one or more sensing service parameters associated with performing the sensing operation, including at least a sensing distance parameter, or a sensing velocity parameter, or a sensing angular parameter, or a sensing signal configuration, or a combination thereof. The sensing scheme may further indicate to use or a modification to at least one of the one or more sensing service parameters. In some examples, the target network entity 105-d may receive the handover request from the source network entity 105-c. In some other examples, the target network entity 105-d may receive a status transfer message indicating the sensing information from the AMF.

At 410, the source network entity 105-c may receive, from the target network entity 105-d, a response message indicating a sensing scheme to enable the UE 115-c to perform sensing during handover based on the requested resource allocation. The response message may include a handover request acknowledgment message indicating the sensing scheme, which may be based on the sensing information transmitted to the target network entity 105-d. Additionally, or alternatively, the source network entity 105-c may receive, from an AMF, a handover command indicating the sensing scheme. The sensing scheme indicated by the response message may indicate a first resource allocation for performing the sensing operation during the handover that is the same as or is different from a second resource allocation used by the UE 115-c for performing the sensing operation prior to the handover. Additionally, or alternatively, the sensing scheme may include an instruction that instructs the UE 115-c to initiate a random access procedure with the target network entity 105-d, including transmission of one or more sensing RS via a requested resource allocation during the handover.

The response message may further indicate that the target network entity 105-d authorizes the UE 115-c to perform the sensing operation during the handover based on the handover request indicating the sensing information. In some cases, the response message may indicate a time duration during which the resource allocation is available for performing the sensing operation.

At 415, the source network entity 105-c may transmit, to the UE 115-c, a handover message triggering the UE 115-c to perform the handover from the source network entity 105-c to the target network entity 105-d and to perform the sensing operation in accordance with the sensing scheme during the handover. In some examples, the handover message is a radio resource control message, a handover command, or both.

At 420, the UE 115-c may perform the handover from the source network entity 105-c to the target network entity 105-d based on receiving the handover message. At 425, the UE 115-c may perform the sensing operation during the handover in accordance with the sensing scheme based on receiving the handover message. That is, the UE 115-c may perform the handover and the sensing operation once it is authorized to do so and based on the information communicated between the source network entity 105-c and the target network entity 105-d.

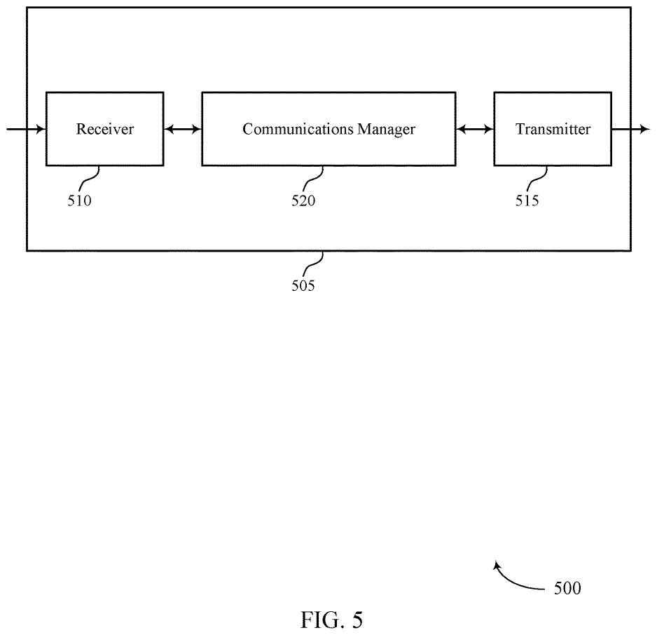

FIG. 5 shows a block diagram 500 of a device 505 that supports indicating sensing information for sensing and handover operations in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520) may include at least one processor, which may be coupled with at least one memory to support the handover enhancement features described herein. Each of these components may be in communication with one another (e.g., via one or more buses).

The receiver 510 may provide a means for obtaining (e.g., receiving, determining, identifying) information such as user data, control information, or a combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or a combination thereof.

The transmitter 515 may provide a means for outputting (e.g., transmitting, providing, conveying, sending) information generated by other components of the device 505. For example, the transmitter 515 may output information such as user data, control information, or a combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or a combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of indicating sensing information for sensing and handover operations as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or a combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or a combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a source network node in accordance with examples as disclosed herein. For example, the communications manager 520 is capable of, configured to, or operable to support a means for transmitting, to a target network node, a handover request for handover of a UE from the source network node to the target network node, the handover request indicating sensing information identifying that the UE is performing a sensing operation for object detection. The communications manager 520 is capable of, configured to, or operable to support a means for receiving, from the target network node, a response message indicating a sensing scheme to enable the UE to perform sensing during the handover from the source network node to the target network node, the sensing scheme based on the sensing information. The communications manager 520 is capable of, configured to, or operable to support a means for transmitting, to the UE, a handover message triggering the UE to perform the handover from the source network node to the target network node and to perform the sensing operation in accordance with the sensing scheme during the handover.

Additionally, or alternatively, the communications manager 520 may support wireless communications at a target network node in accordance with examples as disclosed herein. For example, the communications manager 520 is capable of, configured to, or operable to support a means for receiving, from a source network node, a handover request for handover of a UE from the source network node to the target network node, the handover request indicating sensing information identifying that the UE is performing a sensing operation for object detection. The communications manager 520 is capable of, configured to, or operable to support a means for transmitting, to the source network node, a response message indicating a sensing scheme to enable the UE to perform the sensing operation during the handover from the source network node to the target network node, the sensing scheme based on the sensing information.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for providing sensing information for sensing and handover operations, which may improve resource coordination during handover, improve reliability of object tracking during sensing, increase signaling quality and throughput, and improve coordination between wireless devices.

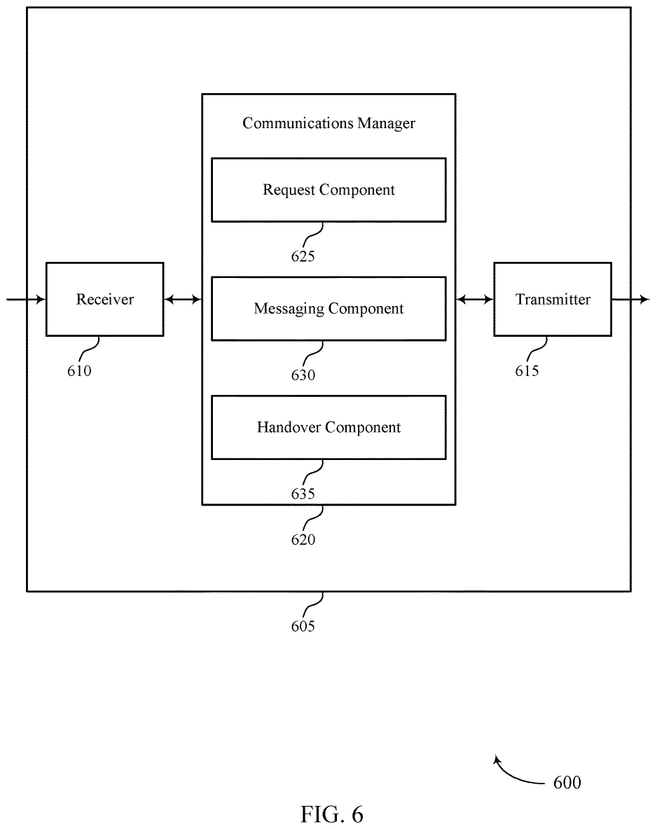

FIG. 6 shows a block diagram 600 of a device 605 that supports indicating sensing information for sensing and handover operations in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620) may include at least one processor, which may be coupled with at least one memory, to support the techniques described herein. Each of these components may be in communication with one another (e.g., via one or more buses).

The receiver 610 may provide a means for obtaining (e.g., receiving, determining, identifying) information such as user data, control information, or a combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or a combination thereof.

The transmitter 615 may provide a means for outputting (e.g., transmitting, providing, conveying, sending) information generated by other components of the device 605. For example, the transmitter 615 may output information such as user data, control information, or a combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or a combination thereof. In some examples, the transmitter 615 and the receiver 610 may be co-located in a transceiver, which may include or be coupled with a modem.

The device 605, or various components thereof, may be an example of means for performing various aspects of indicating sensing information for sensing and handover operations as described herein. For example, the communications manager 620 may include a request component 625, a messaging component 630, a handover component 635, or a combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a source network node in accordance with examples as disclosed herein. The request component 625 is capable of, configured to, or operable to support a means for transmitting, to a target network node, a handover request for handover of a UE from the source network node to the target network node, the handover request indicating sensing information identifying that the UE is performing a sensing operation for object detection. The messaging component 630 is capable of, configured to, or operable to support a means for receiving, from the target network node, a response message indicating a sensing scheme to enable the UE to perform sensing during the handover from the source network node to the target network node, the sensing scheme based on the sensing information. The handover component 635 is capable of, configured to, or operable to support a means for transmitting, to the UE, a handover message triggering the UE to perform the handover from the source network node to the target network node and to perform the sensing operation in accordance with the sensing scheme during the handover.

Additionally, or alternatively, the communications manager 620 may support wireless communications at a target network node in accordance with examples as disclosed herein. The request component 625 is capable of, configured to, or operable to support a means for receiving, from a source network node, a handover request for handover of a UE from the source network node to the target network node, the handover request indicating sensing information identifying that the UE is performing a sensing operation for object detection. The messaging component 630 is capable of, configured to, or operable to support a means for transmitting, to the source network node, a response message indicating a sensing scheme to enable the UE to perform the sensing operation during the handover from the source network node to the target network node, the sensing scheme based on the sensing information.

In some cases, the request component 625, the messaging component 630, and the handover component 635 may each be or be at least a part of at least one processor (e.g., a transceiver processor, or a radio processor, or a transmitter processor, or a receiver processor). The processor may be coupled with memory and execute instructions stored in the memory that enable the processor to perform or facilitate the features of the request component 625, the messaging component 630, and the handover component 635 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

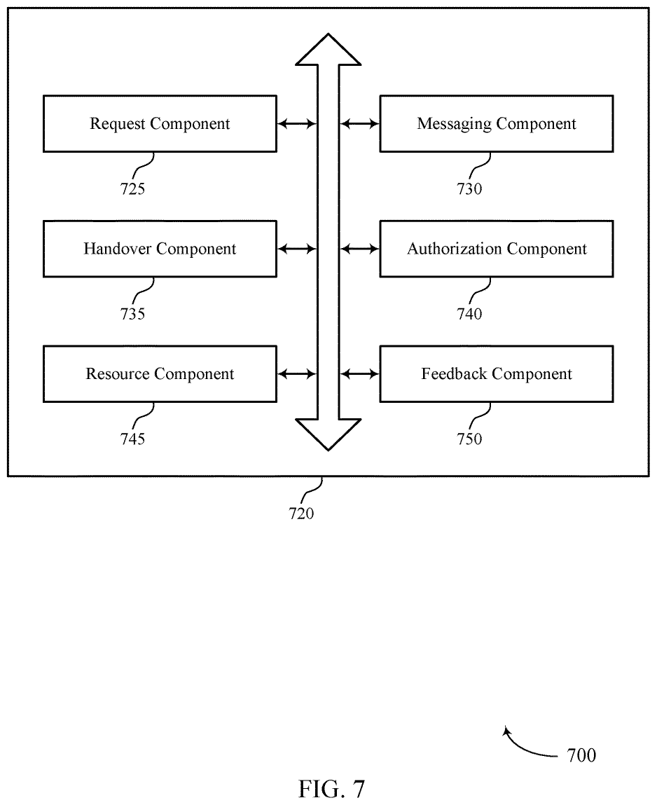

FIG. 7 shows a block diagram 700 of a communications manager 720 that supports indicating sensing information for sensing and handover operations in accordance with one or more aspects of the present disclosure. The communications manager 720 may be an example of aspects of a communications manager 520, a communications manager 620, or both, as described herein. The communications manager 720, or various components thereof, may be an example of means for performing various aspects of indicating sensing information for sensing and handover operations as described herein. For example, the communications manager 720 may include a request component 725, a messaging component 730, a handover component 735, an authorization component 740, a resource component 745, a feedback component 750, or a combination thereof. Each of these components, or sub-components thereof (e.g., at least one processor, at least one memory) may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or a combination thereof.

The communications manager 720 may support wireless communications at a source network node in accordance with examples as disclosed herein. The request component 725 is capable of, configured to, or operable to support a means for transmitting, to a target network node, a handover request for handover of a UE from the source network node to the target network node, the handover request indicating sensing information identifying that the UE is performing a sensing operation for object detection. The messaging component 730 is capable of, configured to, or operable to support a means for receiving, from the target network node, a response message indicating a sensing scheme to enable the UE to perform sensing during the handover from the source network node to the target network node, the sensing scheme based on the sensing information. The handover component 735 is capable of, configured to, or operable to support a means for transmitting, to the UE, a handover message triggering the UE to perform the handover from the source network node to the target network node and to perform the sensing operation in accordance with the sensing scheme during the handover.

In some examples, to support transmitting the handover request, the request component 725 is capable of, configured to, or operable to support a means for transmitting, to an AMF for relay to the target network node as the handover request, a handover instruction message that instructs the target network node to coordinate with the source network node for the handover of the UE to the target network node.

In some examples, to support receiving the response message, the authorization component 740 is capable of, configured to, or operable to support a means for receiving the response message indicating that the target network node authorizes the UE to perform the sensing operation during the handover based on the handover request indicating the sensing information.

In some examples, to support transmitting the handover request, the resource component 745 is capable of, configured to, or operable to support a means for transmitting, via the handover request, the sensing information that indicates a requested resource allocation for performing the sensing operation during the handover, where the sensing scheme is based on the requested resource allocation.

In some examples, the sensing scheme indicated by the response message identifies a resource allocation for performing the sensing operation during the handover that is the same as or is different from the requested resource allocation. In some examples, the response message indicates a time duration during which the resource allocation is available for performing the sensing operation.

In some examples, the sensing scheme enables the UE to initiate a random access procedure with the target network node, where the random access procedure includes transmission of one or more sensing RSs via a requested resource allocation during the handover.

In some examples, the sensing information indicates one or more sensing service parameters associated with performing the sensing operation, where the one or more sensing service parameters include at least a sensing distance parameter, or a sensing velocity parameter, or a sensing angular parameter, or a sensing signal configuration, or a combination thereof, and where the sensing scheme indicates to use or a modification to at least one of the one or more sensing service parameters.

In some examples, to support receiving the response message, the feedback component 750 is capable of, configured to, or operable to support a means for receiving, from the target network node, the response message including a handover request acknowledgment message indicating the sensing scheme.

In some examples, to support receiving the response message, the handover component 735 is capable of, configured to, or operable to support a means for receiving, from an AMF, a handover command indicating the sensing scheme. In some examples, the handover message is a radio resource control message, a handover command, or both.

Additionally, or alternatively, the communications manager 720 may support wireless communications at a target network node in accordance with examples as disclosed herein. In some examples, the request component 725 is capable of, configured to, or operable to support a means for receiving, from a source network node, a handover request for handover of a UE from the source network node to the target network node, the handover request indicating sensing information identifying that the UE is performing a sensing operation for object detection. In some examples, the messaging component 730 is capable of, configured to, or operable to support a means for transmitting, to the source network node, a response message indicating a sensing scheme to enable the UE to perform the sensing operation during the handover from the source network node to the target network node, the sensing scheme based on the sensing information.

In some examples, to support receiving the handover request, the request component 725 is capable of, configured to, or operable to support a means for receiving, from an AMF, the handover request that instructs the target network node to coordinate with the source network node for the handover of the UE to the target network node.

In some examples, to support transmitting the response message, the authorization component 740 is capable of, configured to, or operable to support a means for transmitting the response message indicating that the target network node authorizes the UE to perform the sensing operation during the handover based on the handover request indicating the sensing information.

In some examples, to support receiving the handover request, the resource component 745 is capable of, configured to, or operable to support a means for receiving, via the handover request, the sensing information that indicates a requested resource allocation for performing the sensing operation during the handover, where the sensing scheme is based on the requested resource allocation.

In some examples, the sensing scheme indicated by the response message identifies a resource allocation for performing the sensing operation during the handover that is the same as or is different from the requested resource allocation.

In some examples, the requested resource allocation is based on a resource allocation associated with the target network node, an interference measurement, or both. In some examples, the response message indicates a time duration during which the requested resource allocation is available for performing the sensing operation.

In some examples, the sensing scheme includes an instruction that instructs the UE to initiate a random access procedure with the target network node. In some examples, to support receiving the handover request, the messaging component 730 is capable of, configured to, or operable to support a means for receiving, from an AMF, a status transfer message indicating the sensing information.

In some examples, the sensing information indicates one or more sensing service parameters associated with performing the sensing operation, where the one or more sensing service parameters include at least a sensing distance parameter, or a sensing velocity parameter, or a sensing angular parameter, or a sensing signal configuration, or a combination thereof, and where the sensing scheme indicates to use or a modification to at least one of the one or more sensing service parameters.

In some examples, to support transmitting the response message, the feedback component 750 is capable of, configured to, or operable to support a means for transmitting, to the source network node, the response message including a handover request acknowledgment message indicating the sensing scheme.

In some examples, to support transmitting the response message, the feedback component 750 is capable of, configured to, or operable to support a means for transmitting, to an AMF, a handover request acknowledgment message indicating the sensing scheme.

In some cases, the communications manager 720, the request component 725, the messaging component 730, the handover component 735, the authorization component 740, the resource component 745, or the feedback component 750 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the communications manager 720, the request component 725, the messaging component 730, the handover component 735, the authorization component 740, the resource component 745, or the feedback component 750 discussed herein.

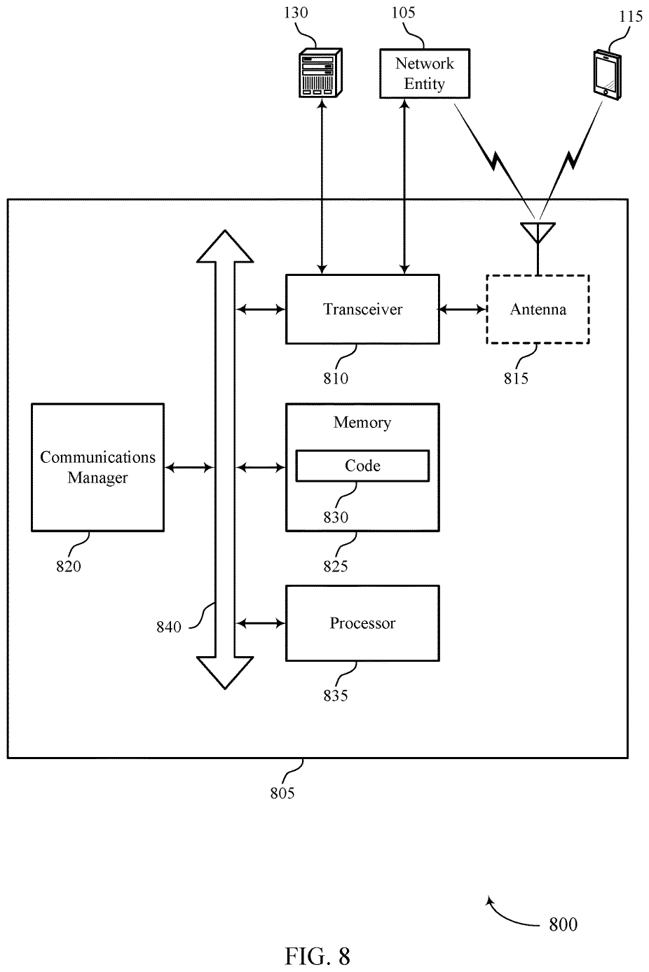

FIG. 8 shows a diagram of a system 800 including a device 805 that supports indicating sensing information for sensing and handover operations in accordance with one or more aspects of the present disclosure. The device 805 may be an example of or include the components of a device 505, a device 605, or a network entity 105 as described herein. The device 805 may communicate with one or more network entities 105, one or more UEs 115, or a combination thereof, which may include communications over one or more wired interfaces, over one or more wireless interfaces, or a combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or a combination thereof. In some implementations, the transceiver 810, or the transceiver 810 and the one or more antennas 815, or the transceiver 810 and the one or more antennas 815 and one or more processors or memory components (for example, the at least one processor 835, or the at least one memory 825, or both), may be included in a chip or chip assembly that is installed in the device 805. In some examples, the transceiver may be operable to support communications via one or more communications links (e.g., a communication link 125, a backhaul communication link 120, a midhaul communication link 162, a fronthaul communication link 168).

The at least one memory 825 may include RAM and ROM. The at least one memory 825 may store computer-readable, computer-executable code 830 including instructions that, when executed by the at least one processor 835, cause the device 805 to perform various functions described herein. The code 830 may be stored in a non-transitory computer-readable medium such as system memory or another type of memory. In some cases, the code 830 may not be directly executable by the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices.

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or a combination thereof). In some cases, the at least one processor 835 may be configured to operate a memory array using a memory controller. In some other cases, a memory controller may be integrated into the at least one processor 835. The at least one processor 835 may be configured to execute computer-readable instructions stored in at least one memory (e.g., the at least one memory 825) to cause the device 805 to perform various functions (e.g., functions or tasks supporting indicating sensing information for sensing and handover operations). For example, the device 805 or a component of the device 805 may include at least one processor 835 and at least one memory 825 coupled with the at least one processor 835, the at least one processor 835 and at least one memory 825 configured to perform various functions described herein. In some examples, the at least one processor 835 may include multiple processors, and the at least one memory 825 may include multiple memories. One or more of the multiple processors may be coupled with one or more of the multiple memories, which may, individually or collectively, be configured to perform various functions herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within the at least one memory 825). In some implementations, the at least one processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the at least one processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications at a source network node in accordance with examples as disclosed herein. For example, the communications manager 820 is capable of, configured to, or operable to support a means for transmitting, to a target network node, a handover request for handover of a UE from the source network node to the target network node, the handover request indicating sensing information identifying that the UE is performing a sensing operation for object detection. The communications manager 820 is capable of, configured to, or operable to support a means for receiving, from the target network node, a response message indicating a sensing scheme to enable the UE to perform sensing during the handover from the source network node to the target network node, the sensing scheme based on the sensing information. The communications manager 820 is capable of, configured to, or operable to support a means for transmitting, to the UE, a handover message triggering the UE to perform the handover from the source network node to the target network node and to perform the sensing operation in accordance with the sensing scheme during the handover.

Additionally, or alternatively, the communications manager 820 may support wireless communications at a target network node in accordance with examples as disclosed herein. For example, the communications manager 820 is capable of, configured to, or operable to support a means for receiving, from a source network node, a handover request for handover of a UE from the source network node to the target network node, the handover request indicating sensing information identifying that the UE is performing a sensing operation for object detection. The communications manager 820 is capable of, configured to, or operable to support a means for transmitting, to the source network node, a response message indicating a sensing scheme to enable the UE to perform the sensing operation during the handover from the source network node to the target network node, the sensing scheme based on the sensing information.

By including or configuring the communications manager 820 in accordance with examples as described herein, the device 805 may support techniques for providing sensing information for sensing and handover operations, which may improve resource coordination during handover, improve reliability of object tracking during sensing, increase signaling quality and throughput, and improve coordination between wireless devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or a combination thereof. Although the communications manager 820 is illustrated as a separate component, in some examples, one or more functions described with reference to the communications manager 820 may be supported by or performed by the transceiver 810, the at least one processor 835, the at least one memory 825, the code 830, or a combination thereof. For example, the code 830 may include instructions executable by the at least one processor 835 to cause the device 805 to perform various aspects of indicating sensing information for sensing and handover operations as described herein, or the at least one processor 835 and the at least one memory 825 may be otherwise configured to perform or support such operations.

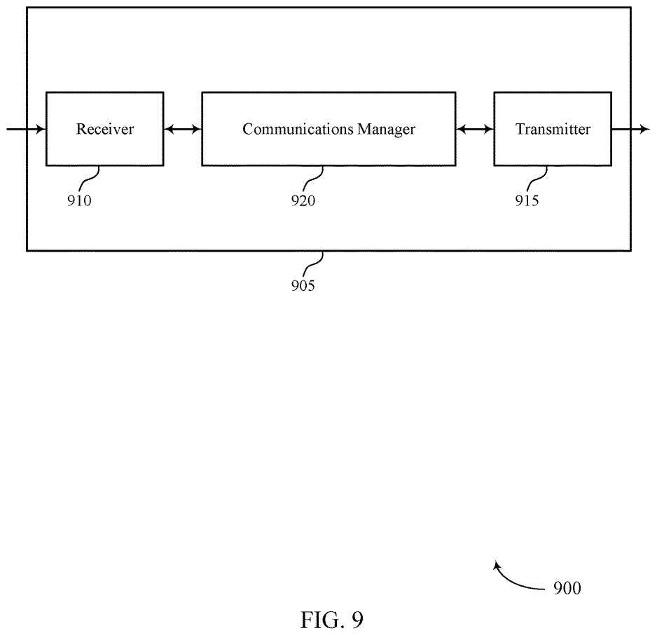

FIG. 9 shows a block diagram 900 of a device 905 that supports indicating sensing information for sensing and handover operations in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920) may include at least one processor, which may be coupled with at least one memory to support the handover enhancement features described herein. Each of these components may be in communication with one another (e.g., via one or more buses).

The receiver 910 may provide a means for receiving information such as packets, user data, control information, or a combination thereof associated with various information channels (e.g., control channels, data channels, information channels related to indicating sensing information for sensing and handover operations). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or a combination thereof associated with various information channels (e.g., control channels, data channels, information channels related to indicating sensing information for sensing and handover operations). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of indicating sensing information for sensing and handover operations as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or a combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or a combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 is capable of, configured to, or operable to support a means for receiving, from a source network node, a handover message triggering the UE to perform a handover from the source network node to a target network node and indicating to perform a sensing operation in accordance with a sensing scheme during the handover. The communications manager 920 is capable of, configured to, or operable to support a means for performing the handover from the source network node to the target network node based on receiving the handover message. The communications manager 920 is capable of, configured to, or operable to support a means for performing the sensing operation during the handover in accordance with the sensing scheme based on receiving the handover message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for providing sensing information for sensing and handover operations, which may improve resource coordination during handover, improve reliability of object tracking during sensing, increase signaling quality and throughput, and improve coordination between wireless devices.

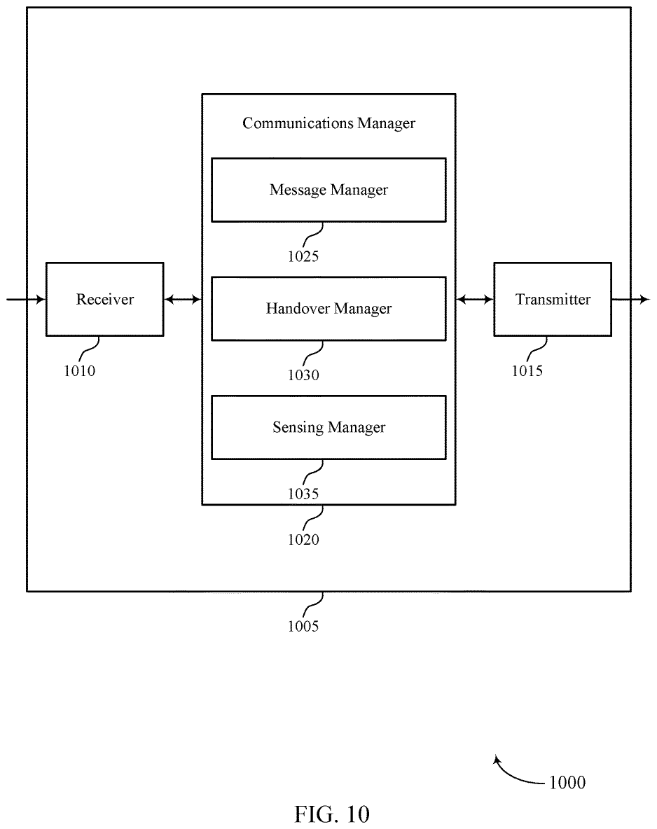

FIG. 10 shows a block diagram 1000 of a device 1005 that supports indicating sensing information for sensing and handover operations in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020) may include at least one processor, which may be coupled with at least one memory, to support the techniques described herein. Each of these components may be in communication with one another (e.g., via one or more buses).

The receiver 1010 may provide a means for receiving information such as packets, user data, control information, or a combination thereof associated with various information channels (e.g., control channels, data channels, information channels related to indicating sensing information for sensing and handover operations). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or a combination thereof associated with various information channels (e.g., control channels, data channels, information channels related to indicating sensing information for sensing and handover operations). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of indicating sensing information for sensing and handover operations as described herein. For example, the communications manager 1020 may include a message manager 1025, a handover manager 1030, a sensing manager 1035, or a combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The message manager 1025 is capable of, configured to, or operable to support a means for receiving, from a source network node, a handover message triggering the UE to perform a handover from the source network node to a target network node and indicating to perform a sensing operation in accordance with a sensing scheme during the handover. The handover manager 1030 is capable of, configured to, or operable to support a means for performing the handover from the source network node to the target network node based on receiving the handover message. The sensing manager 1035 is capable of, configured to, or operable to support a means for performing the sensing operation during the handover in accordance with the sensing scheme based on receiving the handover message.

In some cases, the message manager 1025, the handover manager 1030, and the sensing manager 1035 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message manager 1025, the handover manager 1030, and the sensing manager 1035 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

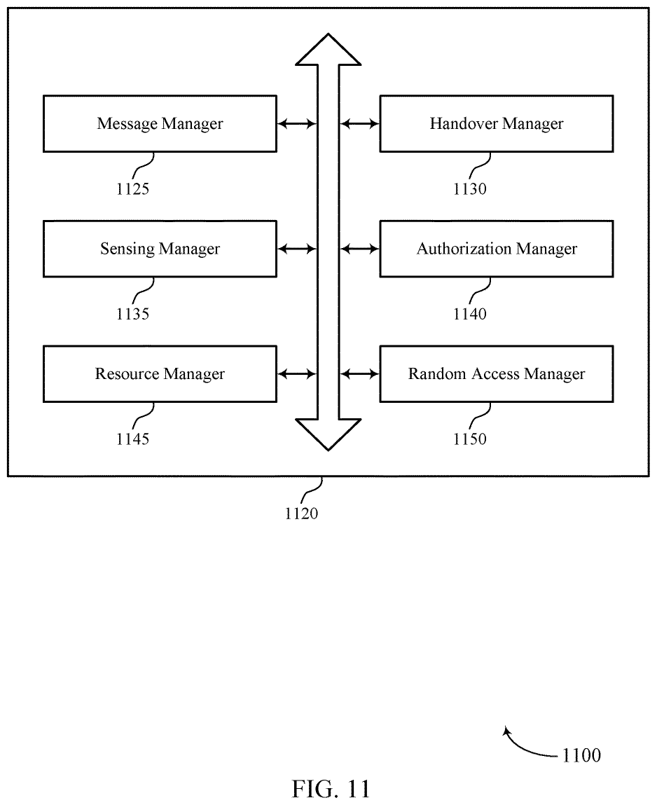

FIG. 11 shows a block diagram 1100 of a communications manager 1120 that supports indicating sensing information for sensing and handover operations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of indicating sensing information for sensing and handover operations as described herein. For example, the communications manager 1120 may include a message manager 1125, a handover manager 1130, a sensing manager 1135, an authorization manager 1140, a resource manager 1145, a random access manager 1150, or a combination thereof. Each of these components, or sub-components thereof (e.g., at least one processor, at least one memory) may communicate, directly or indirectly, with one another (e.g., via one or more buses).

The communications manager 1120 may support wireless communications at a UE in accordance with examples as disclosed herein. The message manager 1125 is capable of, configured to, or operable to support a means for receiving, from a source network node, a handover message triggering the UE to perform a handover from the source network node to a target network node and indicating to perform a sensing operation in accordance with a sensing scheme during the handover. The handover manager 1130 is capable of, configured to, or operable to support a means for performing the handover from the source network node to the target network node based on receiving the handover message. The sensing manager 1135 is capable of, configured to, or operable to support a means for performing the sensing operation during the handover in accordance with the sensing scheme based on receiving the handover message.

In some examples, to support receiving the handover message, the authorization manager 1140 is capable of, configured to, or operable to support a means for receiving the handover message indicating that the target network node authorizes the UE to perform the sensing operation during the handover.

In some examples, the sensing scheme indicates a resource allocation for performing the sensing operation. In some examples, the handover message indicates a time duration during which a resource allocation is available for performing the sensing operation.

In some examples, the sensing scheme indicates a first resource allocation for performing the sensing operation during the handover that is the same as or is different from a second resource allocation used by the UE for performing the sensing operation prior to the handover.

In some examples, one or more sensing service parameters are associated with performing the sensing operation, where the one or more sensing service parameters include at least a sensing distance parameter, or a sensing velocity parameter, or a sensing angular parameter, or a sensing signal configuration, or a combination thereof, and where the sensing scheme indicates to use or a modification to at least one of the one or more sensing service parameters. In some examples, the sensing scheme includes an instruction that instructs the UE to initiate a random access procedure with the target network node.

In some examples, to support performing the sensing operation, the resource manager 1145 is capable of, configured to, or operable to support a means for transmitting one or more sensing RSs during the handover via a first resource allocation that is the same as a second resource allocation used by the UE for performing the sensing operation prior to the handover.

In some examples, to support performing the sensing operation, the resource manager 1145 is capable of, configured to, or operable to support a means for transmitting one or more sensing RSs during the handover via a first resource allocation that is different from a second resource allocation used by the UE for performing the sensing operation prior to the handover.

In some examples, to support performing the handover, the random access manager 1150 is capable of, configured to, or operable to support a means for initiating a random access procedure with the target network node based on receiving the handover message. In some examples, the handover message is a radio resource control message, a handover command, or both.

In some cases, the message manager 1125, the handover manager 1130, the sensing manager 1135, the authorization manager 1140, the resource manager 1145, and the random access manager 1150 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message manager 1125, the handover manager 1130, the sensing manager 1135, the authorization manager 1140, the resource manager 1145, and the random access manager 1150 discussed herein.

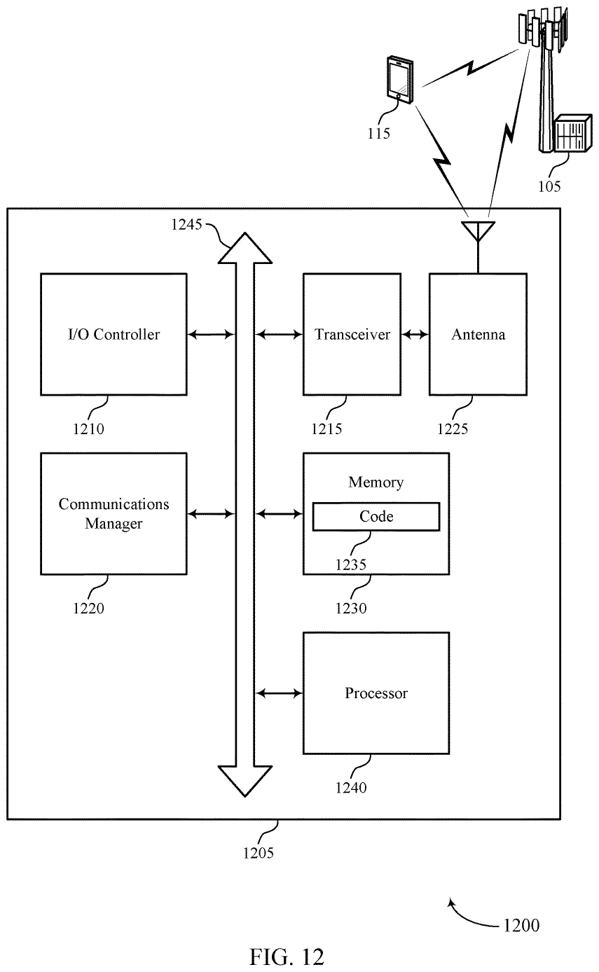

FIG. 12 shows a diagram of a system 1200 including a device 1205 that supports indicating sensing information for sensing and handover operations in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or a combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of at least one processor, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions.

The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or a combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or a combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in at least one memory (e.g., the at least one memory 1230) to cause the device 1205 to perform various functions (e.g., functions or tasks supporting indicating sensing information for sensing and handover operations).

For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors, and the at least one memory 1230 may include multiple memories. One or more of the multiple processors may be coupled with one or more of the multiple memories, which may, individually or collectively, be configured to perform various functions herein.

The communications manager 1220 may support wireless communications at a UE in accordance with examples as disclosed herein. For example, the communications manager 1220 is capable of, configured to, or operable to support a means for receiving, from a source network node, a handover message triggering the UE to perform a handover from the source network node to a target network node and indicating to perform a sensing operation in accordance with a sensing scheme during the handover. The communications manager 1220 is capable of, configured to, or operable to support a means for performing the handover from the source network node to the target network node based on receiving the handover message. The communications manager 1220 is capable of, configured to, or operable to support a means for performing the sensing operation during the handover in accordance with the sensing scheme based on receiving the handover message.

By including or configuring the communications manager 1220 in accordance with examples as described herein, the device 1205 may support techniques for providing sensing information for sensing and handover operations, which may improve resource coordination during handover, improve reliability of object tracking during sensing, increase signaling quality and throughput, and improve coordination between wireless devices.

In some examples, the communications manager 1220 may be configured to perform various operations (e.g., receiving, monitoring, transmitting) using or otherwise in cooperation with the transceiver 1215, the one or more antennas 1225, or a combination thereof. Although the communications manager 1220 is illustrated as a separate component, in some examples, one or more functions described with reference to the communications manager 1220 may be supported by or performed by the at least one processor 1240, the at least one memory 1230, the code 1235, or a combination thereof. For example, the code 1235 may include instructions executable by the at least one processor 1240 to cause the device 1205 to perform various aspects of indicating sensing information for sensing and handover operations as described herein, or the at least one processor 1240 and the at least one memory 1230 may be otherwise configured to perform or support such operations.

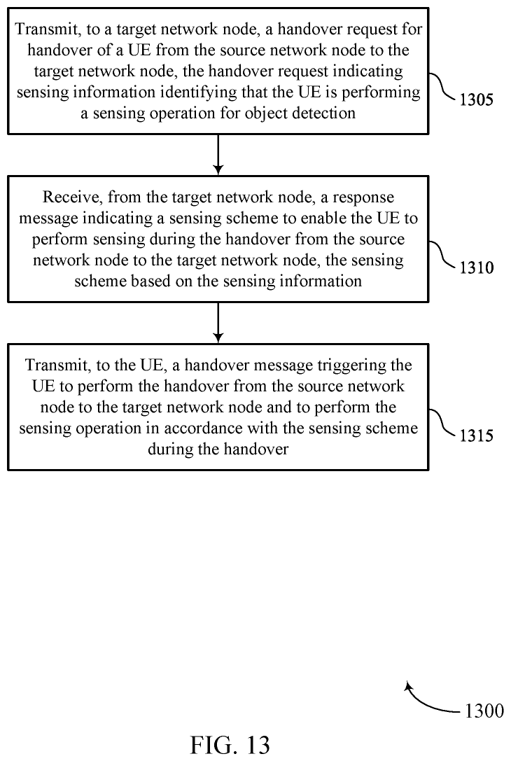

FIG. 13 shows a flowchart illustrating a method 1300 that supports indicating sensing information for sensing and handover operations in accordance with aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include transmitting, to a target network node, a handover request for handover of a UE from the source network node to the target network node, the handover request indicating sensing information identifying that the UE is performing a sensing operation for object detection. The operations of 1305 may be performed in accordance with examples as disclosed herein. In some examples, aspects of the operations of 1305 may be performed by a request component 725 as described with reference to FIG. 7.

At 1310, the method may include receiving, from the target network node, a response message indicating a sensing scheme to enable the UE to perform sensing during the handover from the source network node to the target network node, the sensing scheme based on the sensing information. The operations of 1310 may be performed in accordance with examples as disclosed herein. In some examples, aspects of the operations of 1310 may be performed by a messaging component 730 as described with reference to FIG. 7.

At 1315, the method may include transmitting, to the UE, a handover message triggering the UE to perform the handover from the source network node to the target network node and to perform the sensing operation in accordance with the sensing scheme during the handover. The operations of 1315 may be performed in accordance with examples as disclosed herein. In some examples, aspects of the operations of 1315 may be performed by a handover component 735 as described with reference to FIG. 7.

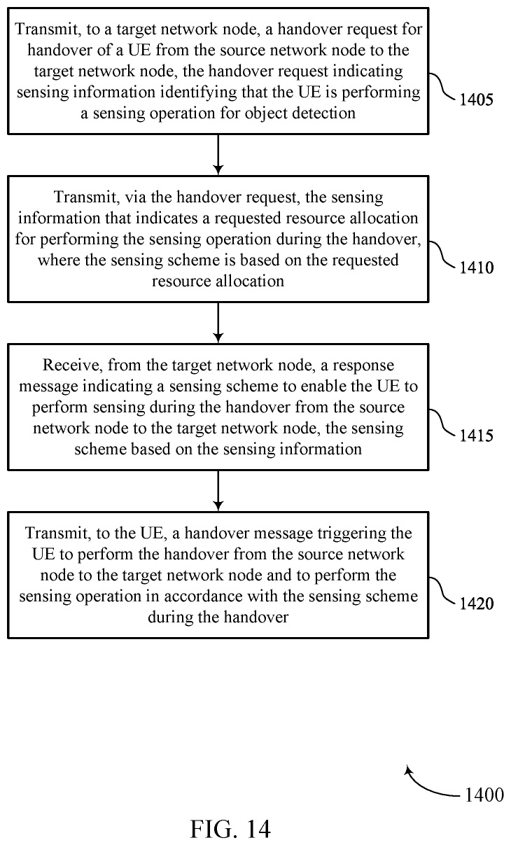

FIG. 14 shows a flowchart illustrating a method 1400 that supports indicating sensing information for sensing and handover operations in accordance with aspects of the present disclosure. The operations of the method 1400 may be implemented by a network node or its components as described herein. For example, the operations of the method 1400 may be performed by a network node as described with reference to FIGS. 1 through 8. In some examples, a network node may execute a set of instructions to control the functional elements of the network node to perform the described functions. Additionally, or alternatively, the network node may perform aspects of the described functions using special-purpose hardware.

At 1405, the method may include transmitting, to a target network node, a handover request for handover of a UE from the source network node to the target network node, the handover request indicating sensing information identifying that the UE is performing a sensing operation for object detection. The operations of 1405 may be performed in accordance with examples as disclosed herein. In some examples, aspects of the operations of 1405 may be performed by a request component 725 as described with reference to FIG. 7.

At 1410, the method may include transmitting, via the handover request, the sensing information that indicates a requested resource allocation for performing the sensing operation during the handover, where the sensing scheme is based on the requested resource allocation. The operations of 1410 may be performed in accordance with examples as disclosed herein. In some examples, aspects of the operations of 1410 may be performed by a resource component 745 as described with reference to FIG. 7.

At 1415, the method may include receiving, from the target network node, a response message indicating a sensing scheme to enable the UE to perform sensing during the handover from the source network node to the target network node, the sensing scheme based on the sensing information. The operations of 1415 may be performed in accordance with examples as disclosed herein. In some examples, aspects of the operations of 1415 may be performed by a messaging component 730 as described with reference to FIG. 7.

At 1420, the method may include transmitting, to the UE, a handover message triggering the UE to perform the handover from the source network node to the target network node and to perform the sensing operation in accordance with the sensing scheme during the handover. The operations of 1420 may be performed in accordance with examples as disclosed herein. In some examples, aspects of the operations of 1420 may be performed by a handover component 735 as described with reference to FIG. 7.

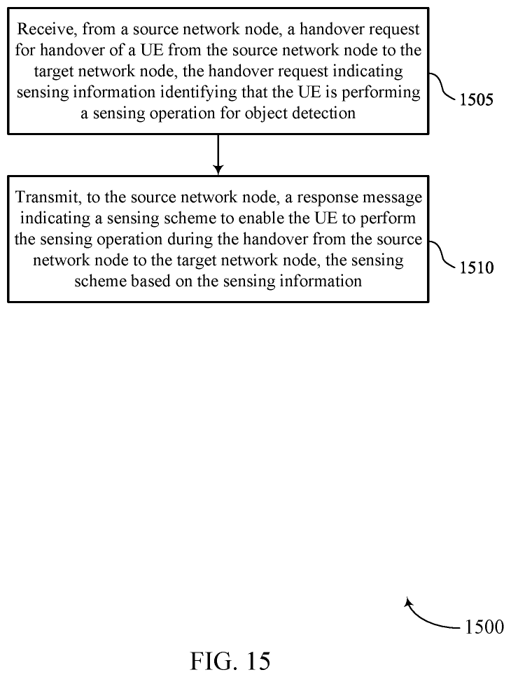

FIG. 15 shows a flowchart illustrating a method 1500 that supports indicating sensing information for sensing and handover operations in accordance with aspects of the present disclosure. The operations of the method 1500 may be implemented by a network node or its components as described herein. For example, the operations of the method 1500 may be performed by a network node as described with reference to FIGS. 1 through 8. In some examples, a network node may execute a set of instructions to control the functional elements of the network node to perform the described functions. Additionally, or alternatively, the network node may perform aspects of the described functions using special-purpose hardware.

At 1505, the method may include receiving, from a source network node, a handover request for handover of a UE from the source network node to the target network node, the handover request indicating sensing information identifying that the UE is performing a sensing operation for object detection. The operations of 1505 may be performed in accordance with examples as disclosed herein. In some examples, aspects of the operations of 1505 may be performed by a request component 725 as described with reference to FIG. 7.

At 1510, the method may include transmitting, to the source network node, a response message indicating a sensing scheme to enable the UE to perform the sensing operation during the handover from the source network node to the target network node, the sensing scheme based on the sensing information. The operations of 1510 may be performed in accordance with examples as disclosed herein. In some examples, aspects of the operations of 1510 may be performed by a messaging component 730 as described with reference to FIG. 7.

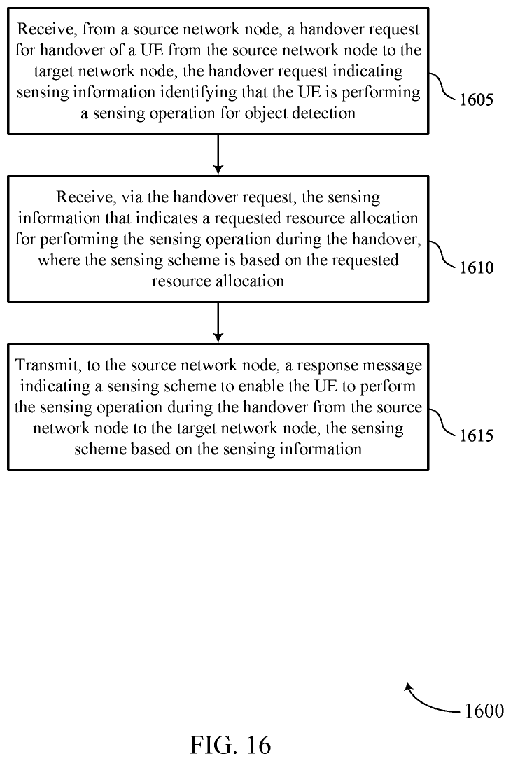

FIG. 16 shows a flowchart illustrating a method 1600 that supports indicating sensing information for sensing and handover operations in accordance with aspects of the present disclosure. The operations of the method 1600 may be implemented by a network node or its components as described herein. For example, the operations of the method 1600 may be performed by a network node as described with reference to FIGS. 1 through 8. In some examples, a network node may execute a set of instructions to control the functional elements of the network node to perform the described functions. Additionally, or alternatively, the network node may perform aspects of the described functions using special-purpose hardware.

At 1605, the method may include receiving, from a source network node, a handover request for handover of a UE from the source network node to the target network node, the handover request indicating sensing information identifying that the UE is performing a sensing operation for object detection. The operations of 1605 may be performed in accordance with examples as disclosed herein. In some examples, aspects of the operations of 1605 may be performed by a request component 725 as described with reference to FIG. 7.

At 1610, the method may include receiving, via the handover request, the sensing information that indicates a requested resource allocation for performing the sensing operation during the handover, where the sensing scheme is based on the requested resource allocation. The operations of 1610 may be performed in accordance with examples as disclosed herein. In some examples, aspects of the operations of 1610 may be performed by a resource component 745 as described with reference to FIG. 7.

At 1615, the method may include transmitting, to the source network node, a response message indicating a sensing scheme to enable the UE to perform the sensing operation during the handover from the source network node to the target network node, the sensing scheme based on the sensing information. The operations of 1615 may be performed in accordance with examples as disclosed herein. In some examples, aspects of the operations of 1615 may be performed by a messaging component 730 as described with reference to FIG. 7.

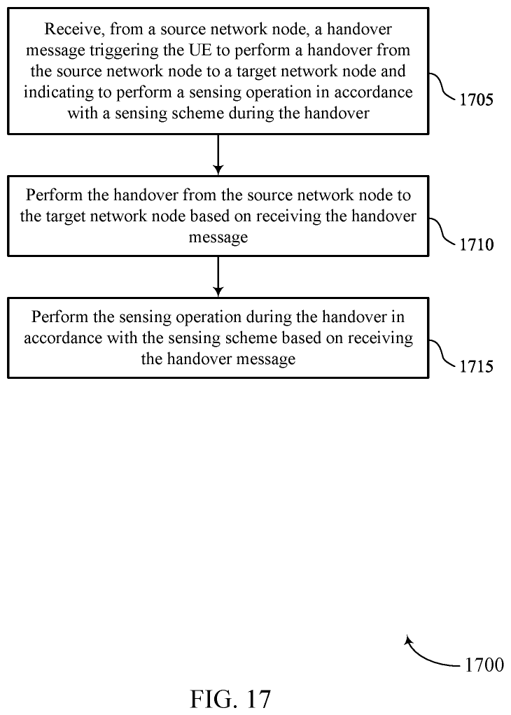

FIG. 17 shows a flowchart illustrating a method 1700 that supports indicating sensing information for sensing and handover operations in accordance with aspects of the present disclosure. The operations of the method 1700 may be implemented by a UE or its components as described herein. For example, the operations of the method 1700 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a source network node, a handover message triggering the UE to perform a handover from the source network node to a target network node and indicating to perform a sensing operation in accordance with a sensing scheme during the handover. The operations of 1705 may be performed in accordance with examples as disclosed herein. In some examples, aspects of the operations of 1705 may be performed by a message manager 1125 as described with reference to FIG. 11.

At 1710, the method may include performing the handover from the source network node to the target network node based on receiving the handover message. The operations of 1710 may be performed in accordance with examples as disclosed herein. In some examples, aspects of the operations of 1710 may be performed by a handover manager 1130 as described with reference to FIG. 11.

At 1715, the method may include performing the sensing operation during the handover in accordance with the sensing scheme based on receiving the handover message. The operations of 1715 may be performed in accordance with examples as disclosed herein. In some examples, aspects of the operations of 1715 may be performed by a sensing manager 1135 as described with reference to FIG. 11.

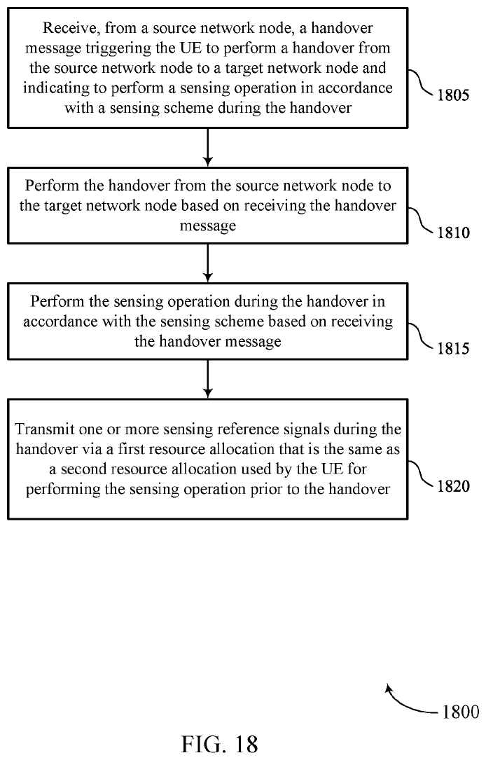

FIG. 18 shows a flowchart illustrating a method 1800 that supports indicating sensing information for sensing and handover operations in accordance with aspects of the present disclosure. The operations of the method 1800 may be implemented by a UE or its components as described herein. For example, the operations of the method 1800 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1805, the method may include receiving, from a source network node, a handover message triggering the UE to perform a handover from the source network node to a target network node and indicating to perform a sensing operation in accordance with a sensing scheme during the handover. The operations of 1805 may be performed in accordance with examples as disclosed herein. In some examples, aspects of the operations of 1805 may be performed by a message manager 1125 as described with reference to FIG. 11.

At 1810, the method may include performing the handover from the source network node to the target network node based on receiving the handover message. The operations of 1810 may be performed in accordance with examples as disclosed herein. In some examples, aspects of the operations of 1810 may be performed by a handover manager 1130 as described with reference to FIG. 11.

At 1815, the method may include performing the sensing operation during the handover in accordance with the sensing scheme based on receiving the handover message. The operations of 1815 may be performed in accordance with examples as disclosed herein. In some examples, aspects of the operations of 1815 may be performed by a sensing manager 1135 as described with reference to FIG. 11.

At 1820, the method may include transmitting one or more sensing RSs during the handover via a first resource allocation that is the same as a second resource allocation used by the UE for performing the sensing operation prior to the handover. The operations of 1820 may be performed in accordance with examples as disclosed herein. In some examples, aspects of the operations of 1820 may be performed by a resource manager 1145 as described with reference to FIG. 11.

The following provides an overview of aspects of the present disclosure:
Aspect 1: A method for wireless communications at a source network entity, comprising: transmitting, to a target network entity, a handover request for handover of a UE from the source network entity to the target network entity, the handover request indicating sensing information identifying that the UE is performing a sensing operation for object detection; receiving, from the target network entity, a response message indicating a sensing scheme to enable the UE to perform sensing during the handover from the source network entity to the target network entity, the sensing scheme based at least in part on the sensing information; and transmitting, to the UE, a handover message triggering the UE to perform the handover from the source network entity to the target network entity and to perform the sensing operation in accordance with the sensing scheme during the handover.
Aspect 2: The method of aspect 1, wherein transmitting the handover request comprises: transmitting, to an AMF for relay to the target network entity as the handover request, a handover instruction message that instructs the target network entity to coordinate with the source network entity for the handover of the UE to the target network entity.
Aspect 3: The method of any of aspects 1 through 2, wherein receiving the response message comprises: receiving the response message indicating that the target network entity authorizes the UE to perform the sensing operation during the handover based at least in part on the handover request indicating the sensing information.
Aspect 4: The method of any of aspects 1 through 3, wherein transmitting the handover request comprises: transmitting, via the handover request, the sensing information that indicates a requested resource allocation for performing the sensing operation during the handover, wherein the sensing scheme is based at least in part on the requested resource allocation.
Aspect 5: The method of aspect 4, wherein the sensing scheme indicated by the response message identifies a resource allocation for performing the sensing operation during the handover that is the same as or is different from the requested resource allocation.
Aspect 6: The method of aspect 5, wherein the response message indicates a time duration during which the resource allocation is available for performing the sensing operation.
Aspect 7: The method of any of aspects 1 through 6, wherein the sensing scheme enables the UE to initiate a random access procedure with the target network entity, wherein the random access procedure includes transmission of one or more sensing RSs via a requested resource allocation during the handover.
Aspect 8: The method of any of aspects 1 through 7, wherein the sensing information indicates one or more sensing service parameters associated with performing the sensing operation, wherein the one or more sensing service parameters comprise at least a sensing distance parameter, or a sensing velocity parameter, or a sensing angular parameter, or a sensing signal configuration, or a combination thereof, and wherein the sensing scheme indicates to use or a modification to at least one of the one or more sensing service parameters.
Aspect 9: The method of any of aspects 1 through 8, wherein receiving the response message comprises: receiving, from the target network entity, the response message comprising a handover request acknowledgment message indicating the sensing scheme.
Aspect 10: The method of any of aspects 1 through 9, wherein receiving the response message comprises: receiving, from an AMF, a handover command indicating the sensing scheme.
Aspect 11: The method of any of aspects 1 through 10, wherein the handover message is a RRC message, a handover command, or both.
Aspect 12: A method for wireless communications at a target network entity, comprising: receiving, from a source network entity, a handover request for handover of a UE from the source network entity to the target network entity, the handover request indicating sensing information identifying that the UE is performing a sensing operation for object detection; and transmitting, to the source network entity, a response message indicating a sensing scheme to enable the UE to perform the sensing operation during the handover from the source network entity to the target network entity, the sensing scheme based at least in part on the sensing information.
Aspect 13: The method of aspect 12, wherein receiving the handover request comprises: receiving, from an AMF, the handover request that instructs the target network entity to coordinate with the source network entity for the handover of the UE to the target network entity.
Aspect 14: The method of any of aspects 12 through 13, wherein transmitting the response message comprises: transmitting the response message indicating that the target network entity authorizes the UE to perform the sensing operation during the handover based at least in part on the handover request indicating the sensing information.
Aspect 15: The method of any of aspects 12 through 14, wherein receiving the handover request comprises: receiving, via the handover request, the sensing information that indicates a requested resource allocation for performing the sensing operation during the handover, wherein the sensing scheme is based at least in part on the requested resource allocation.
Aspect 16: The method of aspect 15, wherein the sensing scheme indicated by the response message identifies a resource allocation for performing the sensing operation during the handover that is the same as or is different from the requested resource allocation.
Aspect 17: The method of any of aspects 15 through 16, wherein the requested resource allocation is based at least in part on a resource allocation associated with the target network entity, an interference measurement, or both.
Aspect 18: The method of any of aspects 15 through 17, wherein the response message indicates a time duration during which the requested resource allocation is available for performing the sensing operation.
Aspect 19: The method of any of aspects 12 through 18, wherein the sensing scheme comprises an instruction that instructs the UE to initiate a random access procedure with the target network entity.
Aspect 20: The method of any of aspects 12 through 19, wherein receiving the handover request comprises: receiving, from an AMF, a status transfer message indicating the sensing information.
Aspect 21: The method of any of aspects 12 through 20, wherein the sensing information indicates one or more sensing service parameters associated with performing the sensing operation, wherein the one or more sensing service parameters comprise at least a sensing distance parameter, or a sensing velocity parameter, or a sensing angular parameter, or a sensing signal configuration, or a combination thereof, and wherein the sensing scheme indicates to use or a modification to at least one of the one or more sensing service parameters.
Aspect 22: The method of any of aspects 12 through 21, wherein transmitting the response message comprises: transmitting, to the source network entity, the response message comprising a handover request acknowledgment message indicating the sensing scheme.
Aspect 23: The method of any of aspects 12 through 22, wherein transmitting the response message comprises: transmitting, to an AMF, a handover request acknowledgment message indicating the sensing scheme.
Aspect 24: A method for wireless communications at a UE, comprising: receiving, from a source network entity, a handover message triggering the UE to perform a handover from the source network entity to a target network entity and indicating to perform a sensing operation in accordance with a sensing scheme during the handover; performing the handover from the source network entity to the target network entity based at least in part on receiving the handover message; and performing the sensing operation during the handover in accordance with the sensing scheme based at least in part on receiving the handover message.
Aspect 25: The method of aspect 24, wherein receiving the handover message comprises: receiving the handover message indicating that the target network entity authorizes the UE to perform the sensing operation during the handover.
Aspect 26: The method of any of aspects 24 through 25, wherein the sensing scheme indicates a resource allocation for performing the sensing operation.
Aspect 27: The method of aspect 26, wherein the handover message indicates a time duration during which a resource allocation is available for performing the sensing operation.
Aspect 28: The method of any of aspects 24 through 27, wherein the sensing scheme indicates a first resource allocation for performing the sensing operation during the handover that is the same as or is different from a second resource allocation used by the UE for performing the sensing operation prior to the handover.
Aspect 29: The method of any of aspects 24 through 28, wherein one or more sensing service parameters are associated with performing the sensing operation, wherein the one or more sensing service parameters comprise at least a sensing distance parameter, or a sensing velocity parameter, or a sensing angular parameter, or a sensing signal configuration, or a combination thereof, and wherein the sensing scheme indicates to use or a modification to at least one of the one or more sensing service parameters.
Aspect 30: The method of any of aspects 24 through 29, wherein the sensing scheme comprises an instruction that instructs the UE to initiate a random access procedure with the target network entity.
Aspect 31: The method of any of aspects 24 through 30, wherein performing the sensing operation comprises: transmitting one or more sensing RSs during the handover via a first resource allocation that is the same as a second resource allocation used by the UE for performing the sensing operation prior to the handover.
Aspect 32: The method of aspect 31, wherein performing the sensing operation comprises: transmitting one or more sensing RSs during the handover via a first resource allocation that is different from a second resource allocation used by the UE for performing the sensing operation prior to the handover.
Aspect 33: The method of any of aspects 24 through 32, wherein performing the handover comprises: initiating a random access procedure with the target network entity based at least in part on receiving the handover message.
Aspect 34: The method of any of aspects 24 through 33, wherein the handover message is a RRC message, a handover command, or both.
Aspect 35: An apparatus for wireless communications at a source network entity, comprising at least one memory; and at least one processor coupled with the at least one memory, the at least one processor configured to perform a method of any of aspects 1 through 11.
Aspect 36: An apparatus for wireless communications at a source network entity, comprising at least one means for performing a method of any of aspects 1 through 11.
Aspect 37: A non-transitory computer-readable medium storing code for wireless communications at a source network entity, the code comprising instructions executable by a processor to perform a method of any of aspects 1 through 11.
Aspect 38: An apparatus for wireless communications at a target network entity, comprising at least one memory; and at least one processor coupled with the at least one memory, the at least one processor configured to perform a method of any of aspects 12 through 23.
Aspect 39: An apparatus for wireless communications at a target network entity, comprising at least one means for performing a method of any of aspects 12 through 23.
Aspect 40: A non-transitory computer-readable medium storing code for wireless communications at a target network entity, the code comprising instructions executable by a processor to perform a method of any of aspects 12 through 23.
Aspect 41: An apparatus for wireless communications at a UE, comprising at least one memory; and at least one processor coupled with the at least one memory, the at least one processor configured to perform a method of any of aspects 24 through 34.
Aspect 42: An apparatus for wireless communications at a UE, comprising at least one means for performing a method of any of aspects 24 through 34.
Aspect 43: A non-transitory computer-readable medium storing code for wireless communications at a UE, the code comprising instructions executable by a processor to perform a method of any of aspects 24 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or a combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or a combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

The functions described herein may be implemented using hardware, software executed by a processor, firmware, or a combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

Any functions or operations described herein as being capable of being performed by a memory may be performed by multiple memories that, individually or collectively, are capable of performing the described functions or operations. For example, the functions described herein may be performed by multiple memories, each tasked with at least a subset of the described functions, such that, collectively, the multiple memories perform all of the described functions. As such, the described functions can be performed by a single memory or a group of memories functioning together (i.e., collectively) to perform the described functions, where any one memory performs at least a subset of the described functions.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a source network node, comprising:
at least one memory; and
at least one processor coupled to the at least one memory, the at least one processor configured to:
transmit, to a target network node, a handover request for handover of a user equipment (UE) from the source network node to the target network node, the handover request indicating sensing information identifying that the UE is performing a sensing operation for object detection;
receive, from the target network node, a response message indicating a sensing scheme to enable the UE to perform sensing during the handover from the source network node to the target network node, the sensing scheme based at least in part on the sensing information; and
transmit, to the UE, a handover message triggering the UE to perform the handover from the source network node to the target network node and to perform the sensing operation in accordance with the sensing scheme during the handover.

2. The apparatus of claim 1, wherein, to transmit the handover request, the at least one processor is configured to:
transmit, to an access and mobility management function (AMF) for relay to the target network node as the handover request, a handover instruction message that instructs the target network node to coordinate with the source network node for the handover of the UE to the target network node.

3. The apparatus of claim 1, wherein, to receive the response message, the at least one processor is configured to:
receive the response message indicating that the target network node authorizes the UE to perform the sensing operation during the handover based at least in part on the handover request indicating the sensing information.

4. The apparatus of claim 1, wherein, to transmit the handover request, the at least one processor is configured to:
transmit, via the handover request, the sensing information that indicates a requested resource allocation for performing the sensing operation during the handover, wherein the sensing scheme is based at least in part on the requested resource allocation;
wherein the sensing scheme indicated by the response message identifies a resource allocation for performing the sensing operation during the handover that is the same as or is different from the requested resource allocation; and
wherein the response message indicates a time duration during which the resource allocation is available for performing the sensing operation.

5-6. (canceled)

7. The apparatus of claim 1, wherein the sensing scheme enables the UE to initiate a random access procedure with the target network node, wherein the random access procedure includes transmission of one or more sensing reference signals via a requested resource allocation during the handover.

8. The apparatus of claim 1, wherein the sensing information indicates one or more sensing service parameters associated with performing the sensing operation, wherein the one or more sensing service parameters comprise at least a sensing distance parameter, or a sensing velocity parameter, or a sensing angular parameter, or a sensing signal configuration, or a combination thereof, and wherein the sensing scheme indicates to use or a modification to at least one of the one or more sensing service parameters.

9. The apparatus of claim 1, wherein, to receive the response message, the at least one processor is configured to:
receive, from the target network node, the response message comprising a handover request acknowledgment message indicating the sensing scheme.

10. The apparatus of claim 1, wherein, to receive the response message, the at least one processor is configured to:
receive, from an access and mobility management function (AMF), a handover command indicating the sensing scheme.

11. The apparatus of claim 1, wherein the handover message is a radio resource control message, a handover command, or both.

12. An apparatus for wireless communications at a target network node, comprising:
at least one memory; and
at least one processor coupled to the at least one memory, the at least one processor configured to:
receive, from a source network node, a handover request for handover of a user equipment (UE) from the source network node to the target network node, the handover request indicating sensing information identifying that the UE is performing a sensing operation for object detection; and
transmit, to the source network node, a response message indicating a sensing scheme to enable the UE to perform the sensing operation during the handover from the source network node to the target network node, the sensing scheme based at least in part on the sensing information.

13. The apparatus of claim 12, wherein, to receive the handover request, the at least one processor is configured to:
receive, from an access and mobility management function (AMF), the handover request that instructs the target network node to coordinate with the source network node for the handover of the UE to the target network node.

14. The apparatus of claim 12, wherein, to transmit the response message, the at least one processor is configured to:
transmit the response message indicating that the target network node authorizes the UE to perform the sensing operation during the handover based at least in part on the handover request indicating the sensing information.

15. The apparatus of claim 12, wherein, to receive the handover request, the at least one processor is configured to:
receive, via the handover request, the sensing information that indicates a requested resource allocation for performing the sensing operation during the handover, wherein the sensing scheme is based at least in part on the requested resource allocation.

16-17. (canceled)

18. The apparatus of claim 15, wherein the response message indicates a time duration during which the requested resource allocation is available for performing the sensing operation.

19-20. (canceled)

21. The apparatus of claim 12, wherein the sensing information indicates one or more sensing service parameters associated with performing the sensing operation, wherein the one or more sensing service parameters comprise at least a sensing distance parameter, or a sensing velocity parameter, or a sensing angular parameter, or a sensing signal configuration, or a combination thereof, and wherein the sensing scheme indicates to use or a modification to at least one of the one or more sensing service parameters.

22-23. (canceled)

24. An apparatus for wireless communications at a user equipment (UE), comprising:
at least one memory; and
at least one processor coupled to the at least one memory, the at least one processor configured to:
receive, from a source network node, a handover message triggering the UE to perform a handover from the source network node to a target network node and indicating to perform a sensing operation in accordance with a sensing scheme during the handover;
perform the handover from the source network node to the target network node based at least in part on receiving the handover message; and
perform the sensing operation during the handover in accordance with the sensing scheme based at least in part on receiving the handover message.

25. The apparatus of claim 24, wherein, to receive the handover message, the at least one processor is configured to:
receive the handover message indicating that the target network node authorizes the UE to perform the sensing operation during the handover.

26. The apparatus of claim 24, wherein the sensing scheme indicates a resource allocation for performing the sensing operation, and wherein the handover message indicates a time duration during which a resource allocation is available for performing the sensing operation.

27. (canceled)

28. The apparatus of claim 24, wherein the sensing scheme indicates a first resource allocation for performing the sensing operation during the handover that is the same as or is different from a second resource allocation used by the UE for performing the sensing operation prior to the handover.

29. The apparatus of claim 24, wherein one or more sensing service parameters are associated with performing the sensing operation, wherein the one or more sensing service parameters comprise at least a sensing distance parameter, or a sensing velocity parameter, or a sensing angular parameter, or a sensing signal configuration, or a combination thereof, and wherein the sensing scheme indicates to use or a modification to at least one of the one or more sensing service parameters.

30. (canceled)
